(19) United States
(12) Patent Application Publication
(10) Pub. No.: US 2014/0164764 A1
(43) Pub. Date: Jun. 12, 2014

(54) ASSIGNMENT OF DIGITAL SIGNATURE AND QUALIFICATION FOR RELATED SERVICES

(71) Applicant: RAWLLIN INTERNATIONAL INC., Tortola (VG)

(72) Inventors: Nikolas Pushkin, Sankt-Petersburg (RU); Andrey Dmitriev, St. Petersburg (RU)

(73) Assignee: RAWLLIN INTERNATIONAL INC., Tortola (VG)

(21) Appl. No.: 13/710,773

(22) Filed: Dec. 11, 2012

(51) Int. Cl. H04L 29/06; H04L 9/32

(52) U.S. Cl. CPC H04L 63/0823; H04L 9/3281
USPC 713/156; 713/176

(57) ABSTRACT

Technologies are generally described for security algorithm methods in issuing, managing, and using digital certificates in online transactions. Certificate holders can be identified based on the device ID from the equipment they are using to access online services. The equipment can be previously linked to an identity known by the equipment service provider. A consumer can then authorize the using of the digital certificate associated with their device in online transactions. Third parties can then trust the identity behind the digital certificates and accept their use in identifying a private party and performing a transaction with that party.

### TECHNICAL FIELD

This application relates to issuing, storing, and managing digital certificates associated with telecommunications equipment for use in payment applications.

### BACKGROUND

As demand for online services has greatly increased, so has the means of accessing online services. Public and private networks can be accessed through a wide variety of means. One online service that has grown substantially is processing online transactions. Customers can purchase products from online retailers, wire payments to individuals, pay bills related to services rendered offline, etc. In processing online transactions, securely and accurately identifying a user that is conducting the transaction is often times necessary to complete the transaction. However, the relative anonymity offered online can lead to complications for both merchants and payment processors a like in trusting the promises made by the parties to an online transaction.

Online services can be accessed through a modem or other device capable of using a wireless or wired network to exchange data. For example, a consumer can purchase a Long Term Evolution (“LTE”) modem and purchase a data plan through an LTE modem service provider in order to access online services using the LTE modem. In most situations, when purchasing the modem and establishing service with a service provider, the service provider will verify the identity of the consumer via checking a physical identification card, running a credit check, running a background check, etc. Thus, a service provider sometimes knows, with near certainty, the identity of the consumer or business using its services.

With customer expectations demanding fast and easy processing of online transactions, having a means to authenticate the identity of a customer that can be used in processing online transactions is desirable. One way of authenticating participants in an online transaction is through the use of digital certificates. Digital certificates can be a trusted source that one party to a transaction uses in order to confidently identify the user of the digital certificate. If a digital certificate could be easily and efficiently established at a time when the identity of a consumer is known to the certificate issuer, online transactions can be processed more reliably.

### SUMMARY

The following presents a simplified summary of the specification in order to provide a basic understanding of some aspects of the specification. This summary is not an extensive overview of the specification. It is intended to neither identify key or critical elements of the specification nor delineate the scope of any particular embodiments of the specification, or any scope of the claims. Its sole purpose is to present some concepts of the specification in a simplified form as a prelude to the more detailed description that is presented in this disclosure.

Systems and methods disclosed herein relate to issuing, validating and using digital certificates. A receiving component can receive a device identifier (ID) from a modem device. A subscriber data component can retrieve profile data representing a personal profile based on the device ID. A certificate component can generate a non-qualified digital certificate and stores the non-qualified digital certificate in a certificate data store wherein the non-qualified digital certificate is associated with the device ID and the profile data.

In another implementation, a validation component can generate a service agreement based on the device ID and the profile data and sends the service agreement to the modem device. The receiving component can further receive signed service agreement data representing a signed service agreement from the modem device. The validation component can validate the signed service agreement data based on, at least in part, the device ID. In response to determining the signed service agreement was validated, the validation component can transform the non-qualified digital certificate in the certificate data store into a qualified digital certificate. A third party component can send an application to the modem device, wherein the application allows the qualified digital certificate in the certificate data store to be used in a transaction with a third party device.

The following description and the drawings set forth certain illustrative aspects of the specification. These aspects are indicative, however, of but a few of the various ways in which the principles of the specification may be employed. Other advantages and novel features of the specification will become apparent from the following detailed description of the specification when considered in conjunction with the drawings.

### BRIEF DESCRIPTION OF THE DRAWINGS

FIG. 1 illustrates an example system for issuing a certificate in accordance with the subject disclosure;

FIG. 2 illustrates an example system for issuing and validating a certificate in accordance with the subject disclosure;

FIG. 3 illustrates an example system for issuing, validating and using a certificate in third party transactions in accordance with the subject disclosure;

FIG. 4 illustrates an example method for issuing a certificate in accordance with the subject disclosure;

FIG. 5 illustrates an example method for issuing and validating a certificate in accordance with the subject disclosure;

FIG. 6 illustrates an example method for issuing, validating and using a certificate in third party transactions in accordance with the subject disclosure;

FIG. 7 illustrates an example client device in accordance with the subject disclosure;

FIG. 8 illustrates an example client device including a third party component in accordance with the subject disclosure;

FIGS. 9 & 10 collectively illustrate an example flow diagram method for acquiring a user certificate;

FIGS. 11 & 12 collectively illustrate an example flow diagram method for acquiring a device certificate;

FIG. 13 illustrates an example flow diagram method for validating a device certificate;

FIG. 14 illustrates an example flow diagram method for sending a one time password;

FIG. 15 illustrates an example flow diagram method for validating a phone;

FIGS. 16 & 17 collectively illustrate an example flow diagram method for signing a document with a key;

FIGS. 18 & 19 collectively illustrate an example flow diagram method for signing a document with a one time password;

FIG. 20 illustrates an example flow diagram method for verifying a document;

FIGS. 21 & 22 collectively illustrate an example flow diagram method for revoking a device certificate;

FIG. 23 illustrates an example schematic block diagram for a computing environment in accordance with the subject specification; and

FIG. 24 illustrates an example block diagram of a computer operable to execute the disclosed architecture.

### DETAILED DESCRIPTION

The various embodiments are now described with reference to the drawings, wherein like reference numerals are used to refer to like elements throughout. In the following description, for purposes of explanation, numerous specific details are set forth in order to provide a thorough understanding of the various embodiments. It may be evident, however, that the various embodiments can be practiced without these specific details. In other instances, well-known structures and devices are shown in block diagram form in order to facilitate describing the various embodiments.

Systems and methods herein provide for identifying consumers and issue digital certificates related to the consumer based on a device, such as a modem, that the consumer uses to access online services. For example, a consumer can purchase a Long Term Evolution (“LTE”) modem and purchase a data plan through an LTE modem service provider in order to access online services using the LTE modem. In most situation, when purchasing the modem and establishing service with a service provider, the service provider will verify the identity of the consumer through checking a physical identification card, running a credit check, running a background check, etc. Thus, a service provider often times knows with the certainty the identity of the consumer or business using its services.

For example, a service provider when selling an LTE modem can review proof of identification from the purchaser. The modem id or device id along with the identification information of the purchaser can be associated with each other. The consumer can be told and/or sign an agreement that states that the modem contains identification information and needs to be treated as personal use only. The consumer could then take the modem to the place they wish to use, and upon installation, a service agreement can be generated between the consumer and the provider whereby the consumer agrees to honor transaction made using their own personalized digital certificate. A third party can then rely on a stored digital certificate as a means to authenticate a party to a transaction.

The architecture disclosed herein can be used to issue, manage, and use digital certificates in online transactions. Operations can be performed over hyper text transfer protocol secure (“HTTPS”) which provides server authentication and data confidentiality between a mobile/web client and a single point of contact (SPOC) server.

In many implementations, various one time passwords can be generated and used in activating certificates, issuing certificates, revoking certificates, etc. For example, a random string of letters and numbers can be generated by a password component. The password component can be adjusted by an administrator the like to adjust the types of characters used or length of a generated password. The password component can reside on a bank server and also generate RND upon request.

An algorithm of hash code generation can be used to generate a HASH, such as using the MD5 or SHA0-1 algorithms. Thus, a client device and a bank server can both calculate HASH independently of each other. Similarly, symmetric-key algorithms (“SYMM”) can be used where the encryption key is related to the decryption key. It can be appreciated that key generation can be uniform or adaptive in various implementations in the subject disclosure.

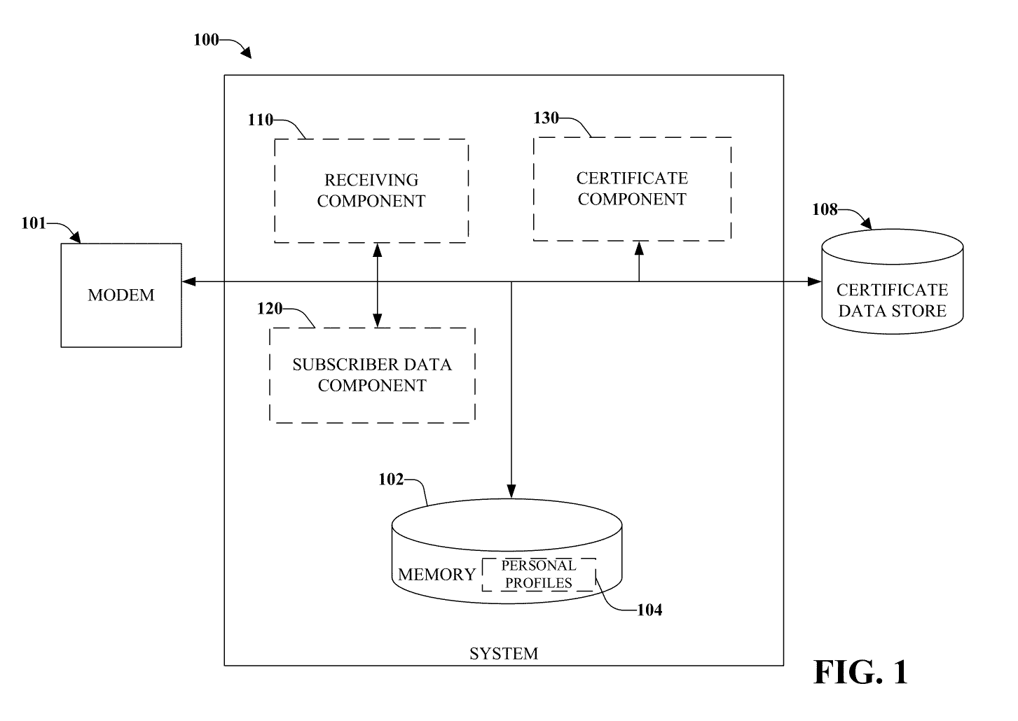

Referring now to FIG. 1, there is illustrated an example system for issuing a certificate in accordance with the subject disclosure. System 100 can be in communication with modem 101. Modem device 101 can be a wireless modem, for example, an LTE modem or wireless modem, capable of connecting with system 100 via a communications network (not shown). Modem device 101 can be external or internal to a client device such as a mobile telephone, Smartphone, tablet, e-reader, laptop computer, desktop computer, etc.

Receiving component 110 can a device identifier (ID) from a modem device 101. In one implementation, the receiving component 110 can receive the device ID from the modem device in response to a determination that the modem device has at least begun being installed.

Subscriber data component 120 can retrieve profile data representing a personal profile 104 based on the device ID. For example, personal profiles 104 stored within memory 102 can be associated with a device ID and used by subscriber data component 120 to retrieve the personal profile associated with modem 101. Personal profiles can contain information related to the identity of the subscriber, billing and contact information related to the subscriber, payment preferences related to the subscriber, links to other modems or devices associated with the subscriber's personal profile, etc. In another example, system 100 can send the device ID, ICCID, SIM Card ID, etc. to a certificate service provider, for the purpose of receiving subscriber data, e.g., a personal profile. The certificate service provider can find the subscriber data using the, for example, SIM Card ID.

A certificate component 130 can generate a non-qualified digital certificate and stores the non-qualified digital certificate in a certificate data store 108 wherein the non-qualified digital certificate is associated with the device ID and the profile data. A non-qualified digital certificate is a digital certificate related to a user or a device that is not-qualified to perform transactions. A qualified digital certificate allows a user and/or a device to perform transactions, such as making a payment, using the qualified digital certificate. For example, a non-qualified digital certificate can be converted into a qualified digital certificate based on verifying a user social security number, a user submitting, an application form, a digitally signed subscriber certificate, etc.

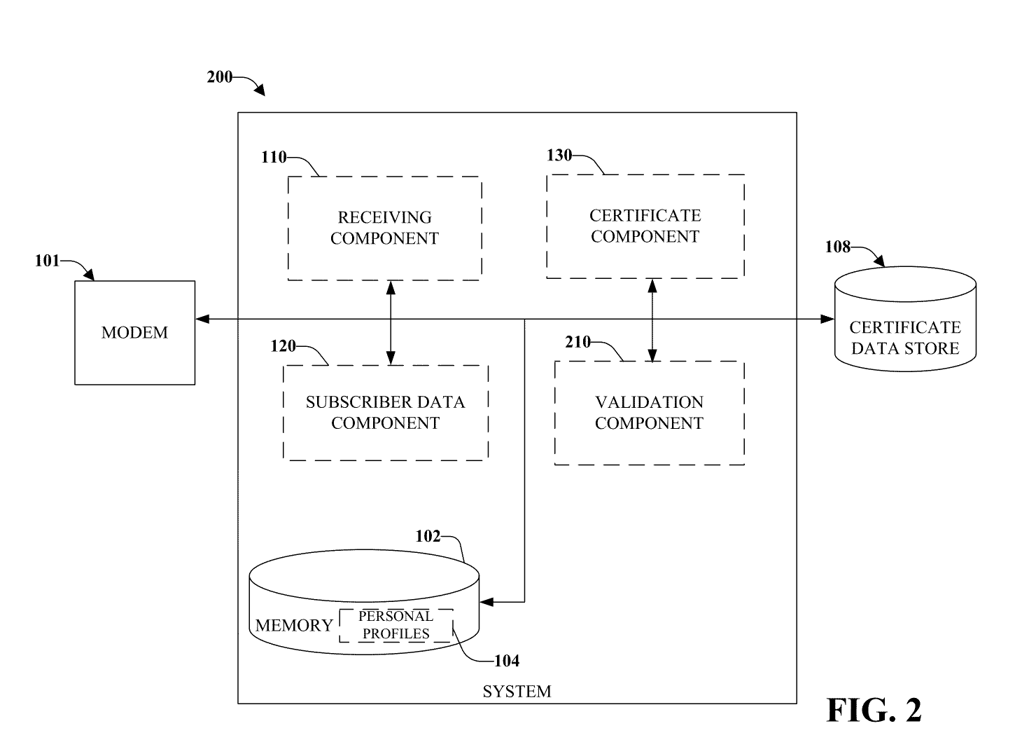

Referring now to FIG. 2, there is illustrated an example system for issuing and validating a certificate in accordance with the subject disclosure. A validation component 210 can generate a service agreement based on the device ID and the profile data and sends the service agreement to the modem device. For example, validation component 210 can populate a standard form service agreement using the device ID and the personal profile, to generate a personalized service agreement specific to the user of the modem. The service agreement can contain any contractual language necessary to bind the subscriber to payments or other transactions effectuated using a qualified digital certificate.

In one implementation, receiving component 110 can receive signed service agreement data representing a signed service agreement from the modem device. In another implementation, validation component 210 can validate the signed service agreement data based on, at least in part, the device ID. For example, validation component can confirm that the device ID reference in the signed service agreement matches the device ID the signed service agreement was received from. In another example, validation component can validate whether personal information related to the subscriber that signed the signed service agreement matches information contained with personal profile 104 of the same subscriber. In one implementation, validation component 210 can send an error message to modem 101 based on receiving an invalid signed service agreement. An example of an invalid signed service agreement can be an improper signature, non-matching device ID, non matching personal profile data, etc.

In another implementation, in response to determining the signed service agreement was validated, validation component 210 can transform the non-qualified digital certificate in the certificate data store into a qualified digital certificate.

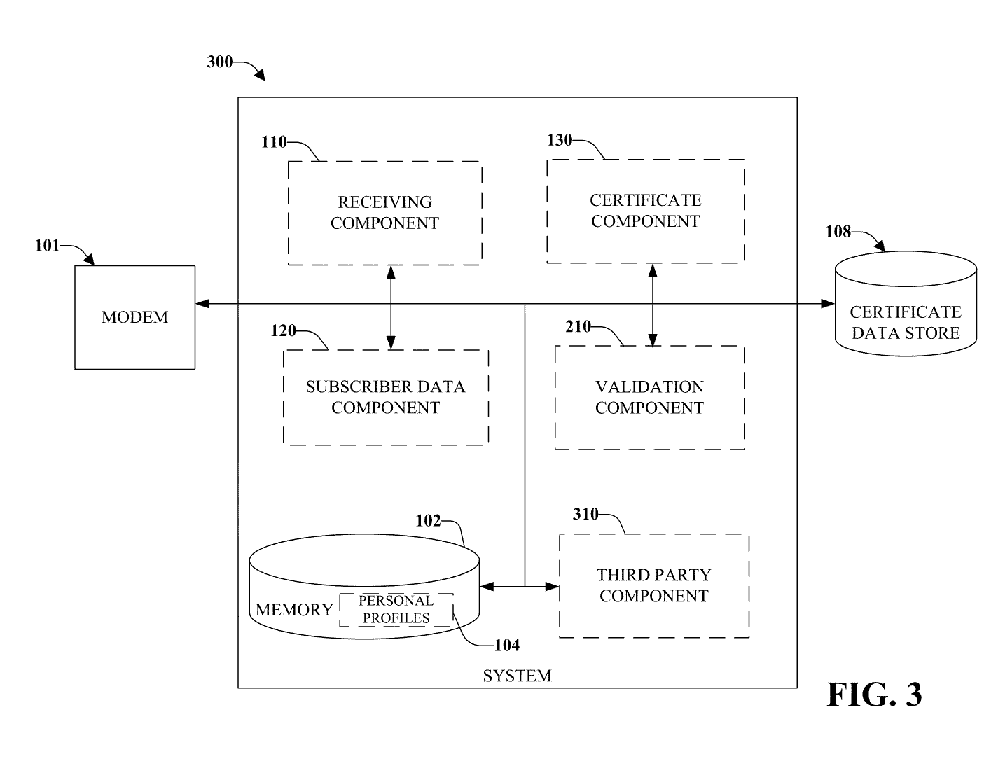

Referring now to FIG. 3, there is illustrated an example system for issuing, validating and using a certificate in third party transactions in accordance with the subject disclosure. Third party component 310 can send an application to the modem device, wherein the application allows the qualified digital certificate in the certificate data store to be used in a transaction with a third party device. For example, a subscriber using modem 101 can use the application to connect through system 100 and certificate data store 108 to sign a payment document related to a transaction. For example, a payment document that authorizes a vendor to charge a subscriber using the digital certificate for services rendered or products sold by the vendor. It can be appreciated that a vendor can feel secure regarding a promise to pay knowing that a certified digital certificate has authenticated the transaction and binds the promise. It can be further appreciated that contractual language within the signed service agreement can bind the subscriber in fulfilling any promises made using the digital certificate.

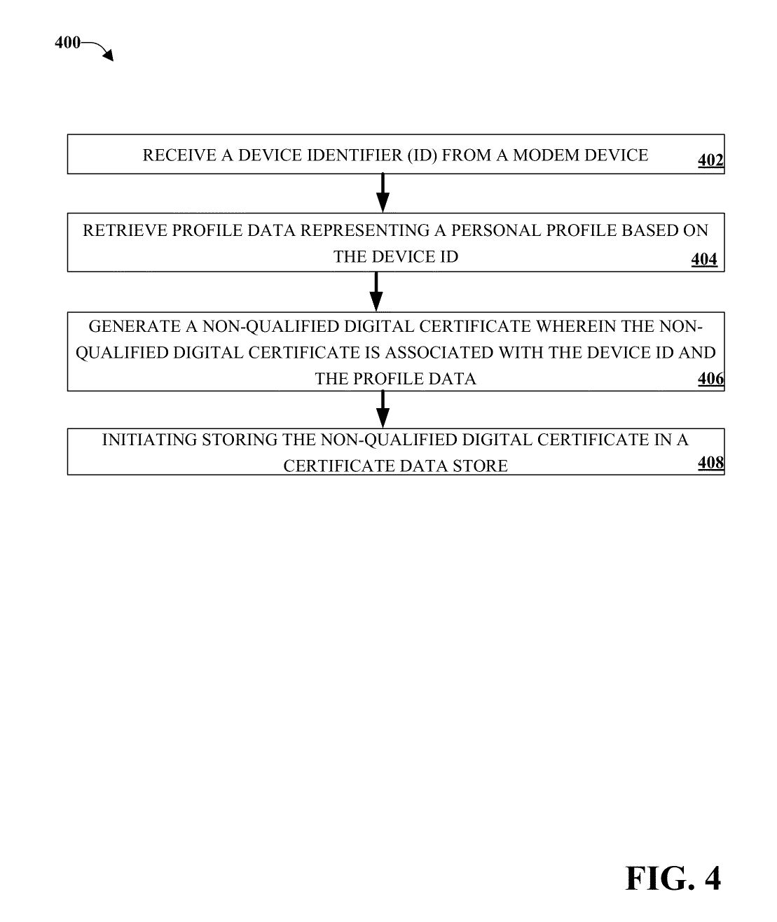

FIGS. 4-6 illustrate methods in accordance with this disclosure. For simplicity of explanation, the methods are depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term article of manufacture, as used herein, is intended to encompass a computer program accessible from any computer-readable device or storage media.

Referring now to FIG. 4, there is illustrated an example method 400 for issuing a certificate in accordance with the subject disclosure. At 402, a device identifier (ID) can be received from a modem device. In one implementation, the receiving the device ID from the modem device is in response to the modem device being determined to have been installed. At 404, profile data representing a personal profile can be retrieved based on the device ID. At 406, a non-qualified digital certificate can be generated wherein the non-qualified digital certificate is associated with the device ID and the profile data. At 408, storing the non-qualified digital certificate in a certificate data store can be initiated.

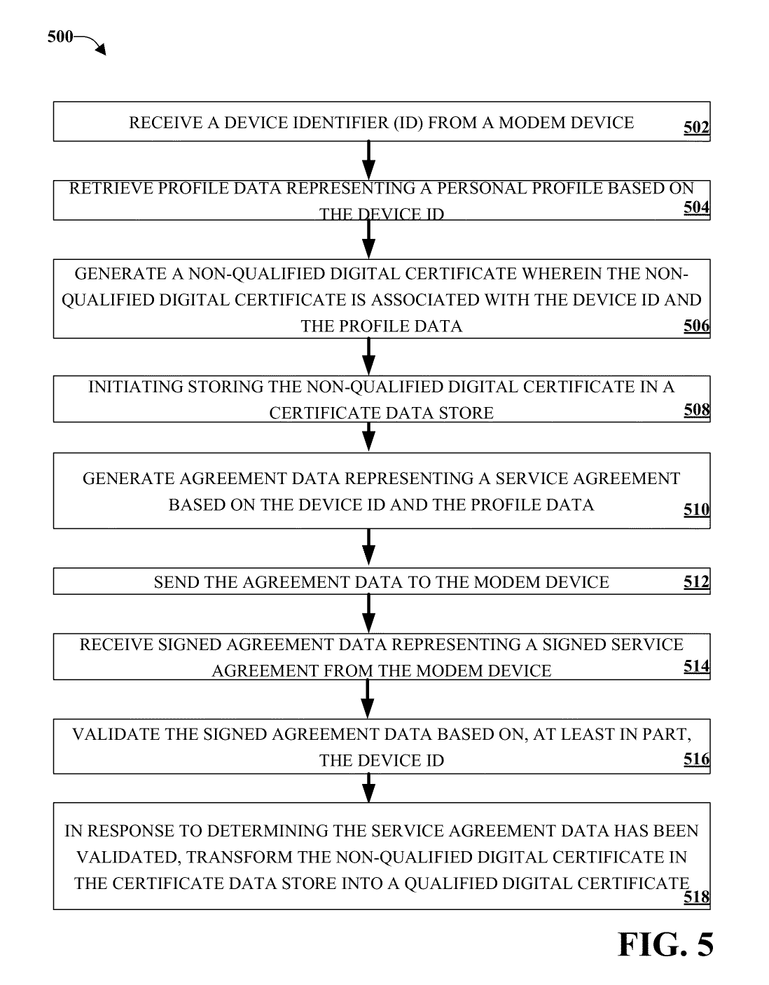

Referring now to FIG. 5, there is illustrated an example method for issuing and validating a certificate in accordance with the subject disclosure. At 502, a device identifier (ID) can be received from a modem device. At 504, profile data representing a personal profile can be retrieved based on the device ID. At 506, a non-qualified digital certificate can be generated wherein the non-qualified digital certificate is associated with the device ID and the profile data. At 508, storing the non-qualified digital certificate in a certificate data store can be initiated.

At 510, agreement data representing a service agreement can be generated based on the device ID and the profile data. At 512, the agreement data can be sent to the modem device. At 514, signed agreement data representing a signed service agreement can be received from the modem device. At 516, the signed agreement data can be validated based on, at least in part, the device ID. At 518, in response to determining the service agreement data has been validated, the non-qualified digital certificate in the certificate data store can be transformed into a qualified digital certificate.

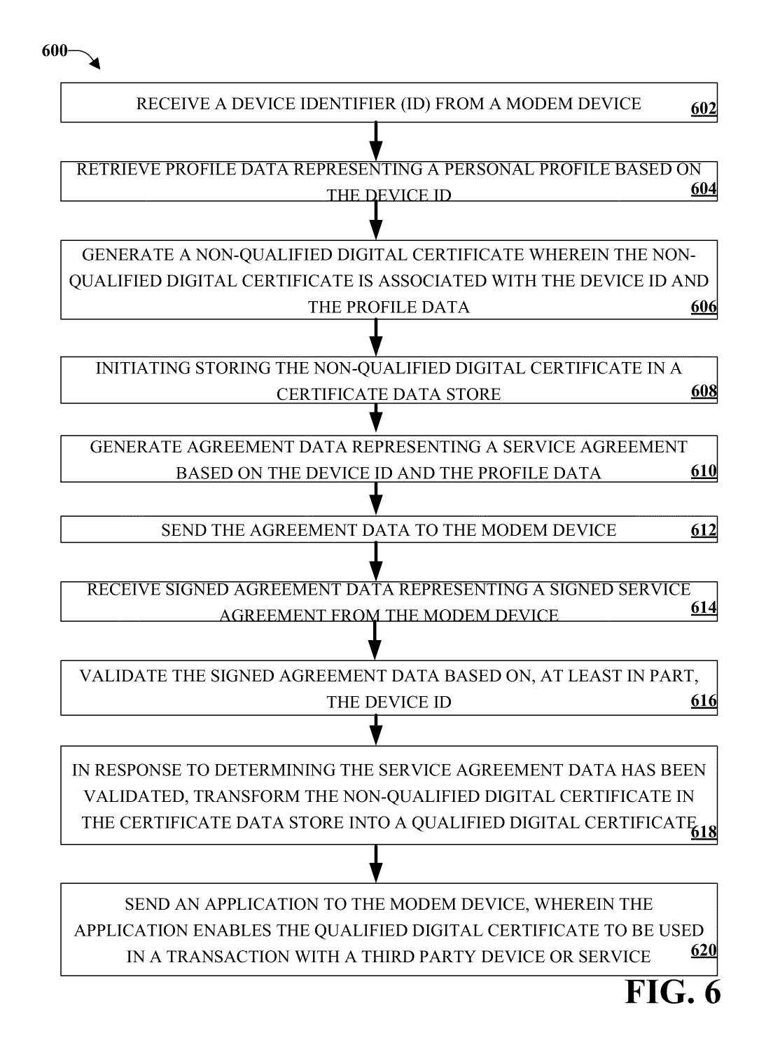

Referring now to FIG. 6, there is illustrated an example method for issuing, validating and using a certificate in third party transactions in accordance with the subject disclosure. At 602, a device identifier (ID) can be received from a modem device. At 604, profile data representing a personal profile can be retrieved based on the device ID. At 606, a non-qualified digital certificate can be generated wherein the non-qualified digital certificate is associated with the device ID and the profile data. At 608, storing the non-qualified digital certificate in a certificate data store can be initiated. At 610, agreement data representing a service agreement can be generated based on the device ID and the profile data. At 612, the agreement data can be sent to the modem device. At 614, signed agreement data representing a signed service agreement can be received from the modem device. At 616, the signed agreement data can be validated based on, at least in part, the device ID. At 618, in response to determining the service agreement data has been validated, the non-qualified digital certificate in the certificate data store can be transformed into a qualified digital certificate. At 620, an application can be sent to the modem device, wherein the application enables the qualified digital certificate to be used in a transaction with a third party device or service.

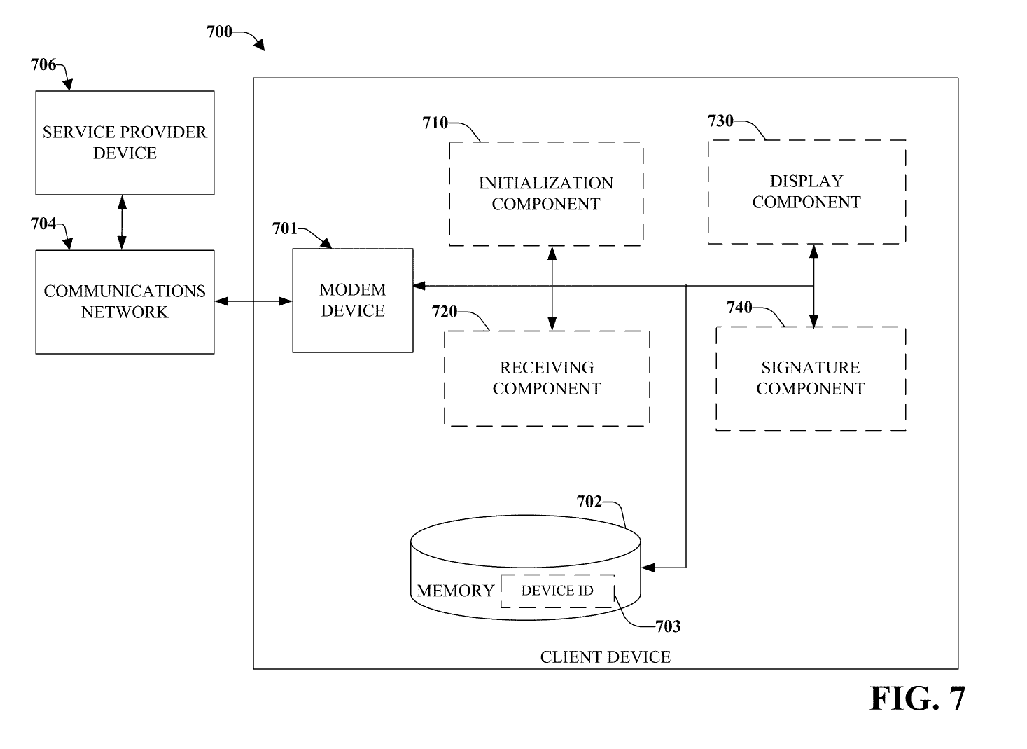

Referring now to FIG. 7, there is illustrated an example client device in accordance with the subject disclosure. Client device 700 can contain at least one memory 702 that stores computer executable components, at least one input (e.g., a keyboard, a mouse, a touch screen, a trackball, a motion sensor, a microphone, etc.), and processor. Modem Device 701 can be internal (as depicted) to client device 700 or external to client device 700. Modem Device 701, in one example, can be an LTE modem. It can be appreciated that other types of modems capable of communicating with a communications network 704 can be similarly used.

Initialization component 710 can send a device identifier (ID) associated with a modem device to a service provider device in response to determining that the modem device has at least begun installation. Receiving component 720 can receive service agreement data representing a service agreement from the service provider device. Display component 730 can, in response to receiving the service agreement data, display the service agreement data. Signature component 740 can receive, from the at least one input, signature data representing a signature, wherein the signature data is sent to the service provider device in response to reception of the signature data.

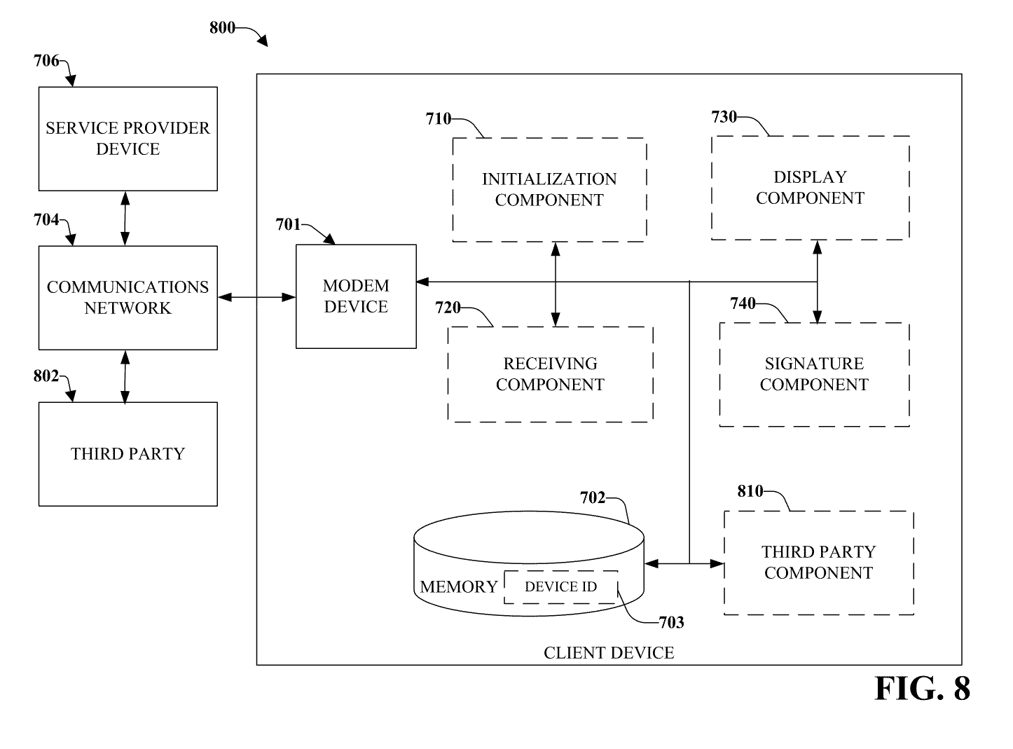

Referring now to FIG. 8, there is illustrated an example client device including a third party component in accordance with the subject disclosure. Third party component 910 can receive and install a third party application from the service provider device, wherein the third party application enables the client device to conduct a transaction with a third party device or service based on the service agreement data. For example, a user of client device 800 can use the third party application in making a payment for a transaction, by using the digital certificate to authenticate the user to the third party.

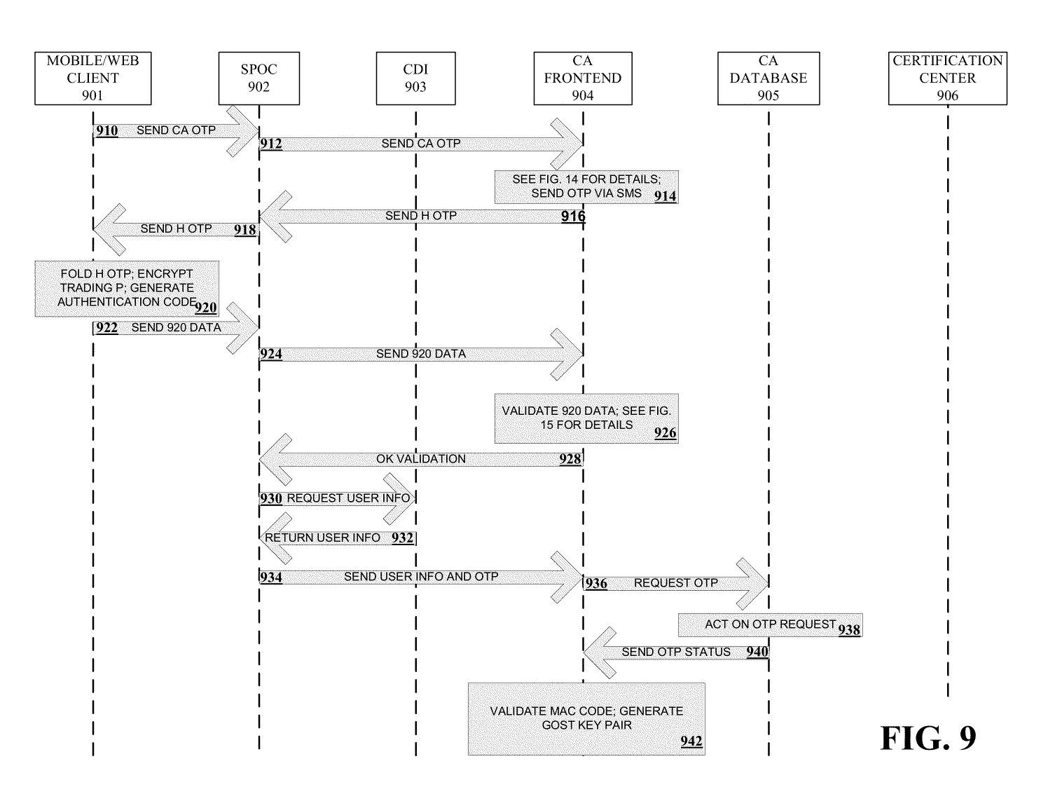

FIGS. 9-22 illustrate methods and/or flow diagrams in accordance with this disclosure. For simplicity of explanation, the methods are depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term article of manufacture, as used herein, is intended to encompass a computer program accessible from any computer-readable device or storage media.

Referring now to FIGS. 9 & 10 collectively, there is illustrated an example flow diagram method for acquiring a user certificate. A mobile/web client 901 (hereinafter “client 901”) can be an application running on a mobile device, a web browser running on a mobile device, a web browser running on a stationary client device, etc. Single point of contact (SPOC) 902 can be a server that is the single point of contact for mobile/web client 901. It can be appreciated that for security purposes, mobile/web client 901 should not be able to access the certificate authority directly as access could allow an unscrupulous mobile/web client to alter or change sensitive information. CDI 903 stores and manages customer information related to subscribers such as user ID, subscriber profiles, etc.

Certificate Authority (CA) frontend 904 can communicate with SPOC 902 while preventing SPOC 902 from directly communicating with CA database 905. CA database 905 can store digital certificates. Certification center 906 can act upon requests for issuing, managing and using digital certificates by CA frontend 904. It can be appreciated that CA frontend 904, CA database 905, and Certification Center 906 can work in conjunction together in issuing, managing and using digital certificates.

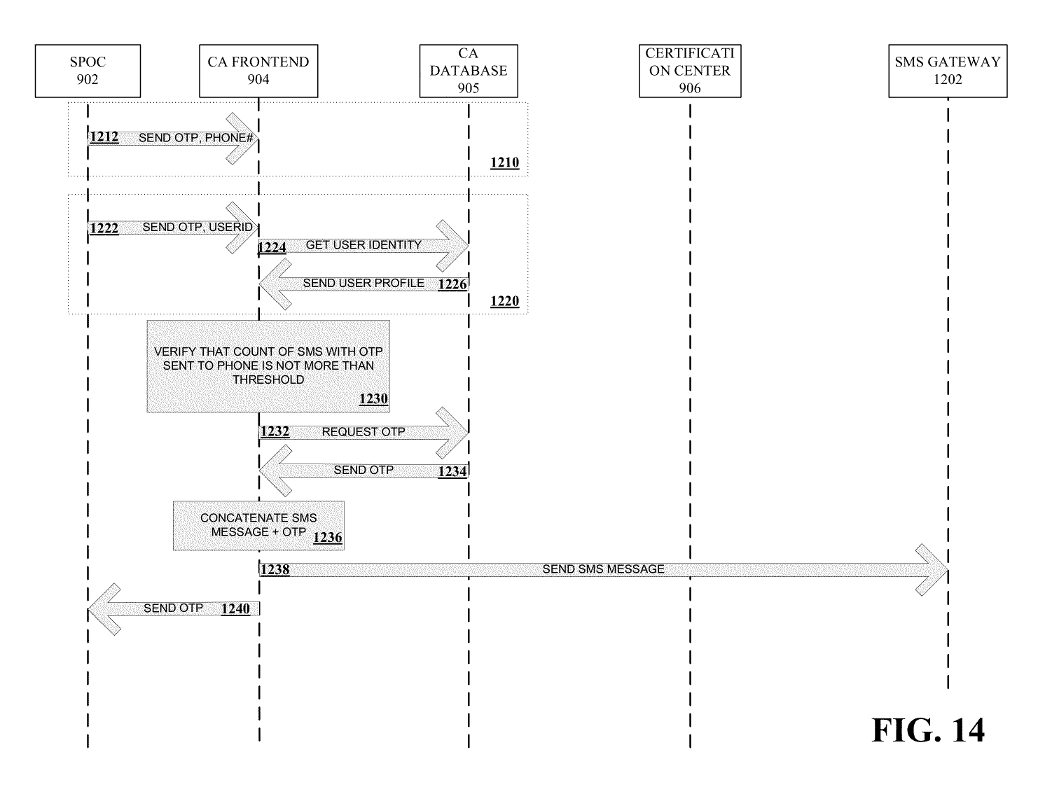

At 910, client 901 can send a one time password (“OTP”) related to the certificate authority (“CA OTP”) to SPOC 902. CA OTP can reference a phone number associated with the subscriber using client 901. At 912, SPOC 902 can send CA OTP to CA frontend 904. At 914, an OTP can be sent to the subscriber associated with the phone number. FIG. 14, as more fully described below, details the implementations for sending the OTP via SMS message to the phone associated with the subscriber. At 916, the same password (“hOTP” or “H OTP”) sent to the phone can be sent to the SPOC 902. At 918, hOTP can be sent to client 901.

At 920, hOTP can be folded into a 4-byte has value. A trading password can by encrypted by concatenating the password string and the 4-byte value into a byte array. A cipher can then be created from the resulting byte array using a CA public key. Additionally, a message authentication code (“MAC”) can be generated based on hOTP, phone#, email, passport, encrypted trading password, and an encrypted keyphrase using, for example, an HmacSHA1 algorithm with the CA OTP as a secret key. At 922, the data generated at 920 can be sent to SPOC 902. At 924, the data generated at 920 can be sent to CA Frontend 904.

At 926,

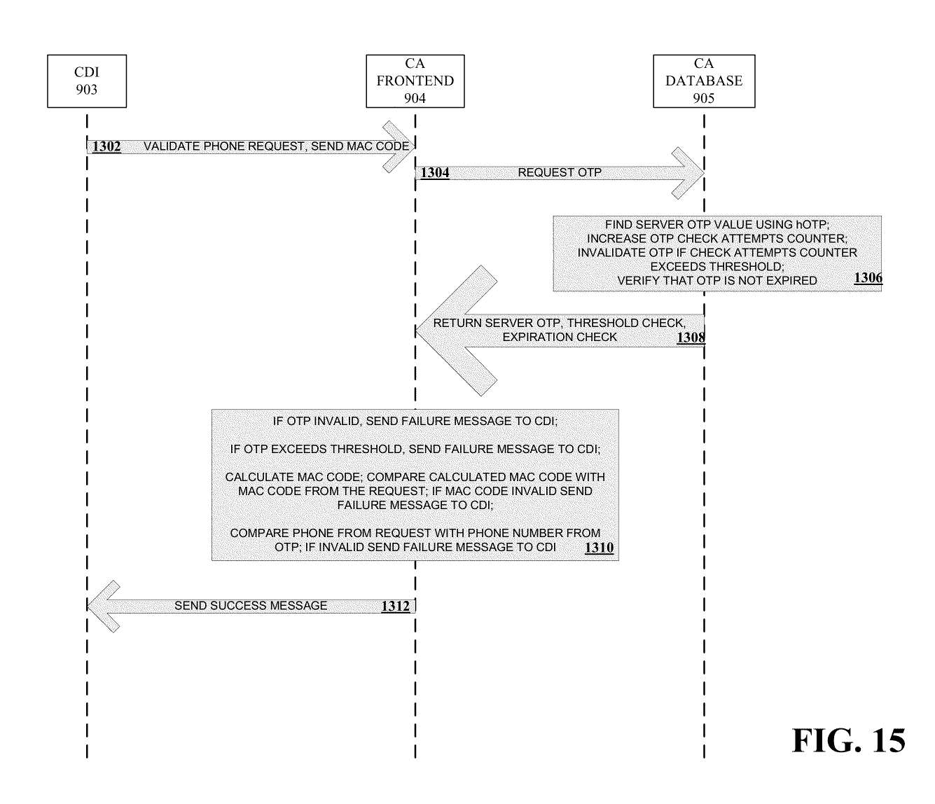

At 926, the data generated at 920 can be validated as more fully described with regard to FIG. 15 below. At 928, a message of validation can be sent to SPOC 902. It can be appreciated that if 920 data is deemed invalid, then a failure message would instead be sent to CDI 903 at 928. At 930, user info can be requested by SPOC 902 with CDI 903. At 932, CDI 903 can return user info to SPOC 902. At 934, the user info and associated OTP can be sent to CA frontend 904.

At 936, CA frontend 904 can request an OTP based on a user identity associated with the user info from CA database 905. At 938, if the userid associated with the user info is already associated with a user certificate, then a failure message can be passed to CA frontend 904, CDI 903 and eventually SPOC 902 that a user certificate already exists and acquiring a user certificate is unnecessary. If a user certificate is not associated with the userid, ca database 905 can find a server OTP value using hOTP. It can maintain a OTP check counter for the user, whereby if the check counter exceeds a threshold, for example, 4 checks, it will not allow issuance of a user certificate. Additionally, if the server OTP is expired, it will not allow issuance of a user certificate. Additionally, if the phone number from the OTP record is not equal to the phone number from the request, a failure message can be returned. At 940, the OTP status can be sent to CA frontend 904, whereby an OK is returned if all the thresholds and verifications are met for issuing a user certificate.

At 942, a MAC can be calculated based on hOTP, phone#, email, passport, encrypted password, encrypted keyphrase using a HmacSHA1 algorithm with the server OTP as the secret key. It can then compare the calculated MAC with the MAC received at 928. If the MAC's do not match, a failure message can be returned to the CDI 903 and SPOC 902. If the MAC's do match, a GOST symmetric key pair can be generated. At 944, a certificate signing request (CSR) can be generated that contains public key signed by private key and the user id. The CSR can use the GOST algorithm. The CSR can be generated using the user information from step 932.

At 946, the CSR can be sent to certification center 906. Certification center can have a dedicated certificate authority certificate and private key used for user certificate authorization, device certificate authorization, and payment password encryption. At 948, certification center 906 can sign the CSR against the CA private key and generate a signed user certificate in, for example, X.509 v3 format. At 950, the signed user certificate can be sent to CA frontend 904.

At 952, the Base64 string and the encrypted password can be converted to a cipher byte array. At 954 the cipher can be sent to certification center 906. At 956, the cipher byte array can be decrypted using the CA private key. At 958, the decrypted cipher can be sent to CA frontend 904. At 960, the trailing 4-bytes of the decrypted data can be cut to get the payment password. An AES symmetric key can be generated from the payment password. A private key can be retrieved from the RSA KeyPair in PKCS #8 format. The Private can then be encrypted with the symmetric key. Finally, the Base 64 string with the encrypted keyphrase can be converted into a cipher byte array.

At 962, the cipher can be sent to certification center 906. At 964, the cipher bye array can be decrypted using the CA private key. At 968, the decrypted cipher can be sent to CA frontend 904. At 970, the decrypted data can be validated by folding hOTP string into 4-byte hash value used as keyphrase, then compare the calculated hash with the 4-trailing bytes of decrypted data. If not the same, a failure message can be returned to the CDI 903. If verified, the keyprhase can be converted to canonical form, and an SHA-1 hash can be calculated of the keyphrase canonical form. A request to add a personal profile can then made with CA database 905 at 972.

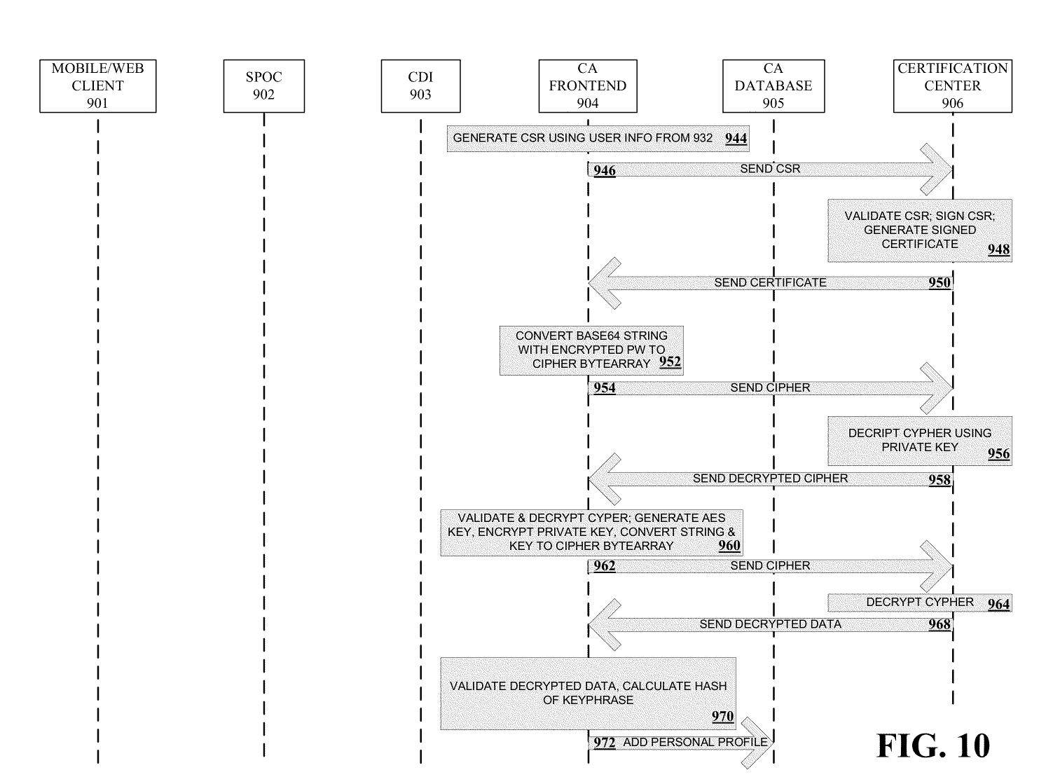

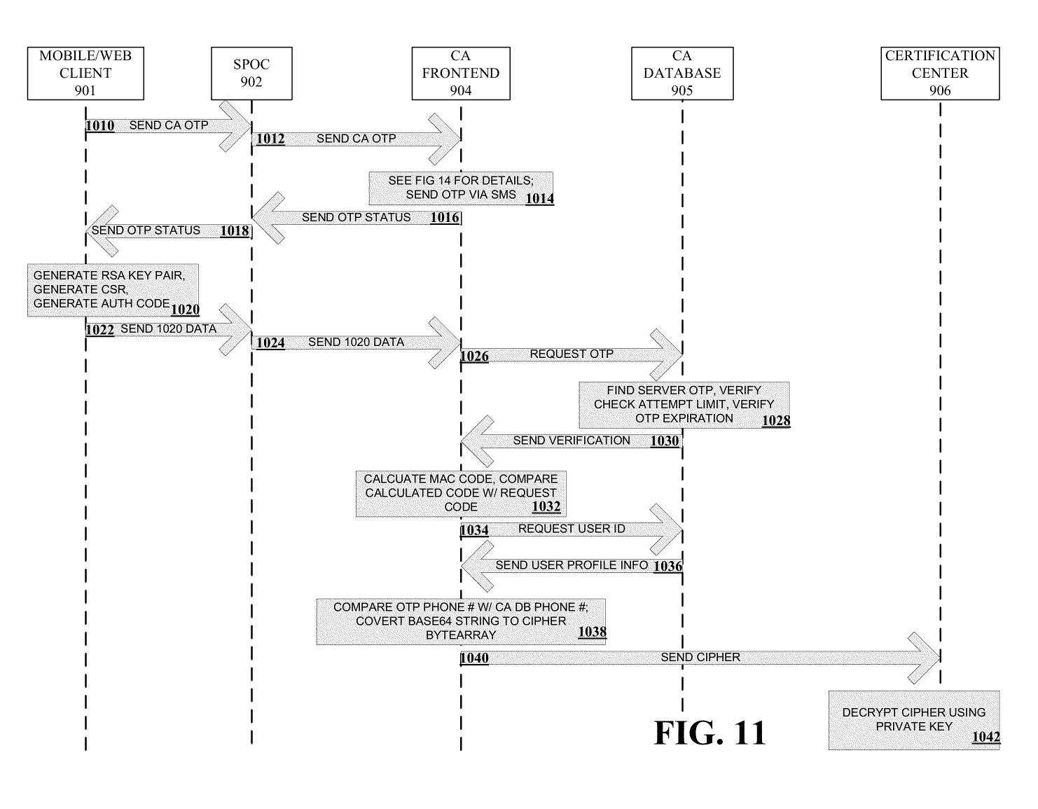

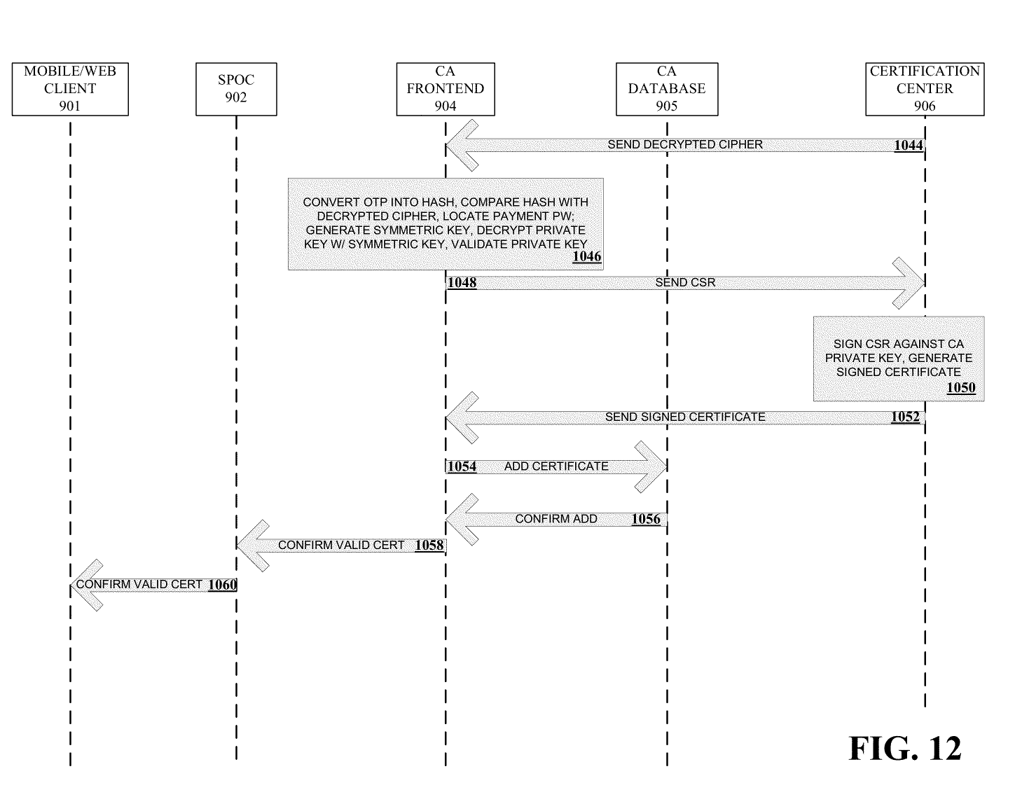

Referring now to FIGS. 11 & 12 collectively, there is illustrated an example flow diagram method for acquiring a device certificate. At 1010, client 901 can send a one time password (“OTP”) related to the certificate authority (“CA OTP”) to SPOC 902. CA OTP can reference a phone number associated with the subscriber using client 901. At 1012, SPOC 902 can send CA OTP to CA frontend 904. At 1014, an OTP can be sent to the subscriber associated with the phone number. FIG. 14, as more fully described below, details the implementations for sending the OTP via SMS message to the phone associated with the subscriber. At 1016, the same password (“hOTP” or “H OTP”) sent to the phone can be sent to the SPOC 902. At 1018, hOTP can be sent to client 901.

At 1020, an RSA key pair can be generated to be used in device authentication. A certificate signed request (CSR) can also be generated with the public key. A MAC can be generated based on hOTP, encrypted password, and the CSR using, for example, HmacSHA1 algorithm with OTP as a secret key. At 1022, the data generated at 1020 can be sent to SPOC 902. At 1024, the data generated at 1020 can be sent to CA frontend 904. At 1026, CA frontend 904 can request the server OTP from CA database 905. At 1028, CA database 905 can find server OTP value suing hOTP. It can increase OTP check attempts counter, and invalidate the request if the counter meets a threshold. It can also verify that the server OTP is not expired. At 1030, CA database 905 can send a phone#, the server OTP, and an OTP status to CA frontend 904. If the OTP status indicates an invalid OTP, a failure message can be returned to SPOC 902.

At 1032, MAC can be calculated based on hOTP, an encrypted password, and a CSR using HmacSHA1 algorithm with OTP server. The calculated MAC can be compared with the MAC from the request. If they do not match, an error message can be returned to SPOC 902. If they match, at 1034, CA frontend can request user profile info by sending the known userid to CA database 905. At 1036, CA database 905 can send the user profile related to the user id, where the profile contains, among other items, a user certificate, a phone number, and an encrypted private key.

At 1038, the phone# returned at 1036 can be compared with the phone# from 1014; if they do not match, an error message can be returned to SPOC 902. Additionally, the Base64 string can be converted with the encrypted password to a cipher byte array. At 1040, the cipher bye array can be sent to certification center 906. At 1042, the cipher byte array can be decrypted using a CA private key. At 1044, the decrypted data can be sent to CA frontend 904.

At 1046, the hOTP string can be folded into a 4-byte hash value to be used as password. Then the hash can be compared with the decrypted cipher. If not equal, a failure message can be returned to SPOC 902. If equal, the trailing 4-bytes of the decrypted data can be cut as used as the payment password. An SES symmetric key can be generated based on the payment password. The PKCS#8 private key can then be decrypted using the symmetric key. The private key can then be validated using the public key from the user certificate. If the private and public keys do not match, an incorrect password message can be sent to SPOC 902. If the CSR is not properly signed or has an incorrect format, a failure message can be sent to SPOC 902.

At 1048, the CSR can be sent to certification center 906. At 1050, the CSR can be signed against the CA private key, and a signed certificate can be generated in X.509 v3 format. At 1052, the signed certificate can be sent to CA frontend 904. At 1054, CA frontend 904 can request that the device certificate be added and/or affiliated with the profile relating to the userid where the device certificate is associated with a serial# of the device. Steps 1056-1060 confirm the adding of the device certificate.

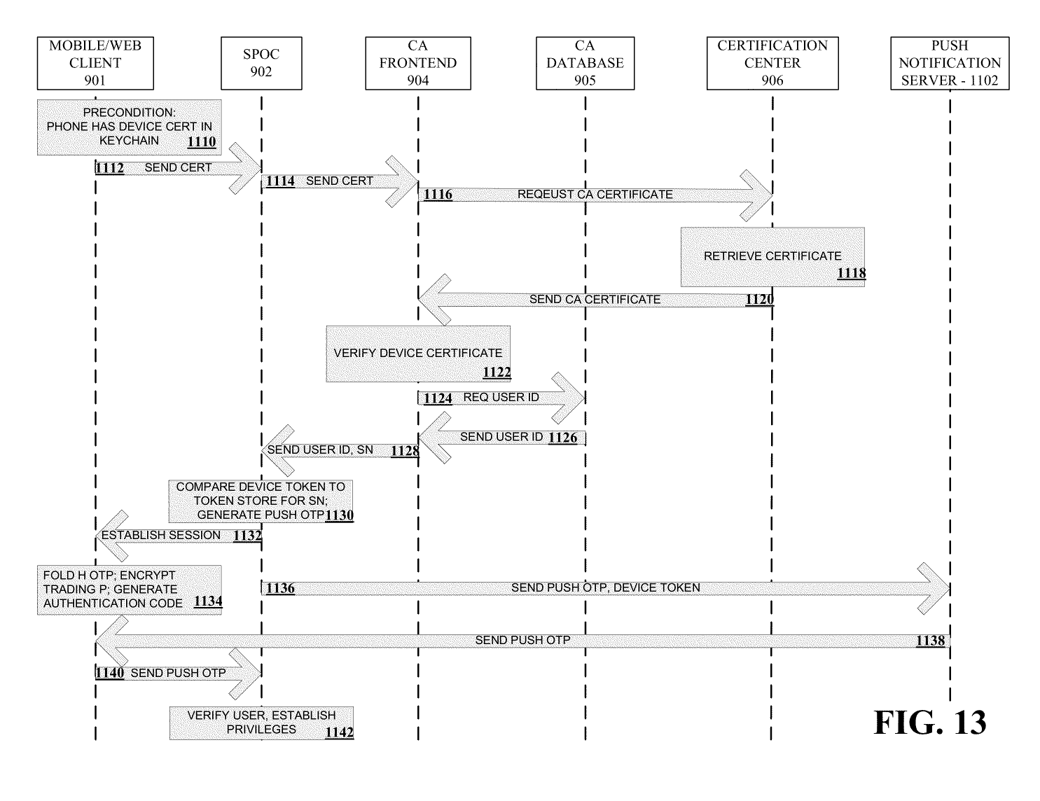

Referring now to FIG. 13, there is illustrated an example flow diagram method for validating a device certificate. Push notification server 1102 can receive a device token related to a device that can receive an SMS or other message, and send a one time password to that device.

At 1110, a precondition of the method is established. Client 901 needs to have a device certificate in its keychain in order to validate whether the device certificate is authentic. At 1112, the device certificate and a device token can be sent to SPOC 902. Device token can be used by push notification server 1102 to identify and validate a corresponding device registered to the device token. At 114, the device certificate can be sent to CA frontend 904. At 1116, CA frontend 904 can request a CA certificate from certification center 906. Certification center 906 has dedicated CA certificates and private keys used for user certification authorization, device certificate authorization, and payment password encryption. At 1118, certification center 906 can retrieve a CA certificate and at 1120, send the CA certification to CA frontend 904.

At 1122, CA frontend 904 can use the CA certificate to determine in the device certificate is valid, if invalid, a failure message can be sent to SPOC 902. CA frontend 904 can also verify whether the device certificate is past an expiration date, if expired, a failure message can be sent to SPOC 902. At 1124, a user ID can be requested from CA database 905 by sending serial# associated with the device. At 1126, a user ID can be returned to CA frontend based on the received serial#. At 1128, the user id and serial number can be returned to SPOC 902. At 1130, SPOC 902 can compare the device token to token stored for serial# at device authorization. If the token is invalid, an error message can be returned to client 901.

At 1132, a session can be established with the device wherein the user is logged in with customer privileges and can see balances and transactions history. Concurrently, at 1136, a push OTP and the device token can be sent to push notification server. At 1138, push notification server 1102 can send the push OTP via SMS message to client 901. If user sends push OTP to SPOC 902 at 1140, at 1142, the user is verified and they now have the privilege and authority to make payments.

Referring now to FIG. 14, there is illustrated an example flow diagram method for sending a one time password. Alternate paths 1210 and 1220 document two different ways to validate a user before sending the OTP. Alternate path 1210 is for a user on a validated phone, which, at 1212, SPOC 902 can send the phone# and text to CA frontend 904. Alternate path 1220 is for a user who needs to be validated by their phone. At 1222, a user id and text can be sent to CA frontend 904. At 1224, CA frontend 904 can request a user identity based on the user id. At 1226, CA database 905 can return a phone#, a user certificate, and an encrypted private key.

At 1230, CA frontend 904 can verify that count of SMS with the OTP sent to the phone# has not met a security threshold. If the threshold has been reached, a failure message can be returned to SPOC 902. At 132, CA frontend 904 can request a CA OTP from CA database 905 using the phone#. At 1234, CA database can send the CA OTP to CA frontend based on the phone#. At 1236, the text can be concatenated with the OTP for sending to a user. At 1238, the concatenated text can be sent to SMS gateway 1202. At 1240, the OTP can be returned to SPOC 902.

Referring now to FIG. 15, there is illustrated an example flow diagram method for validating a phone. At 1302, CDI 903 can send a (1) request to validate phone which includes a phone#, email, passport, encrypted password, and encrypted keyprhase; a (2) MAC based on hOTP, phone#, email, passport, encrypted password, and encrypted keyphrase; and (3) hOTP. CA frontend 904 can request server OTP from CA database 905 by sending hOTP. At 1306, CA database 905 can find the server OTP value using hOTP, increase a counter for requesting the specific OTP, verify the counter hasn't reached a security threshold and also verify if the server OTP is expired.

At 1308, CA database 905 can return the server OTP and an OTP status if applicable, such as security threshold being reached or an expired server OTP. At 1310, If the status indicates an invalid server OTP, a failure message can be sent to CDI 903. Mac can be calculated for hOTP, phone#, email, passport encrypted password, and encrypted keyphrase using HmacSHA1 algorithm with OTP server value. Then the calculated MAC can be compared with the MAC received at 1302. If MAC are not equal, a failure message can be returned to CDI 903. Otherwise a success message can be sent to CDI 903 at 1312.

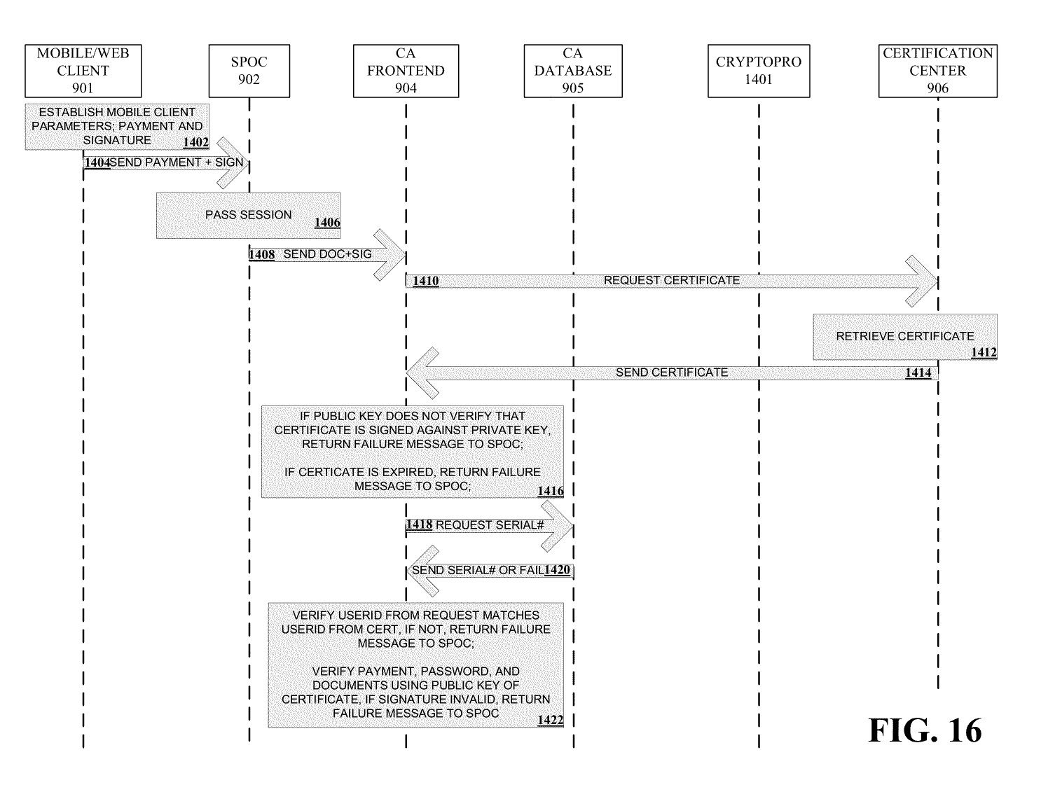

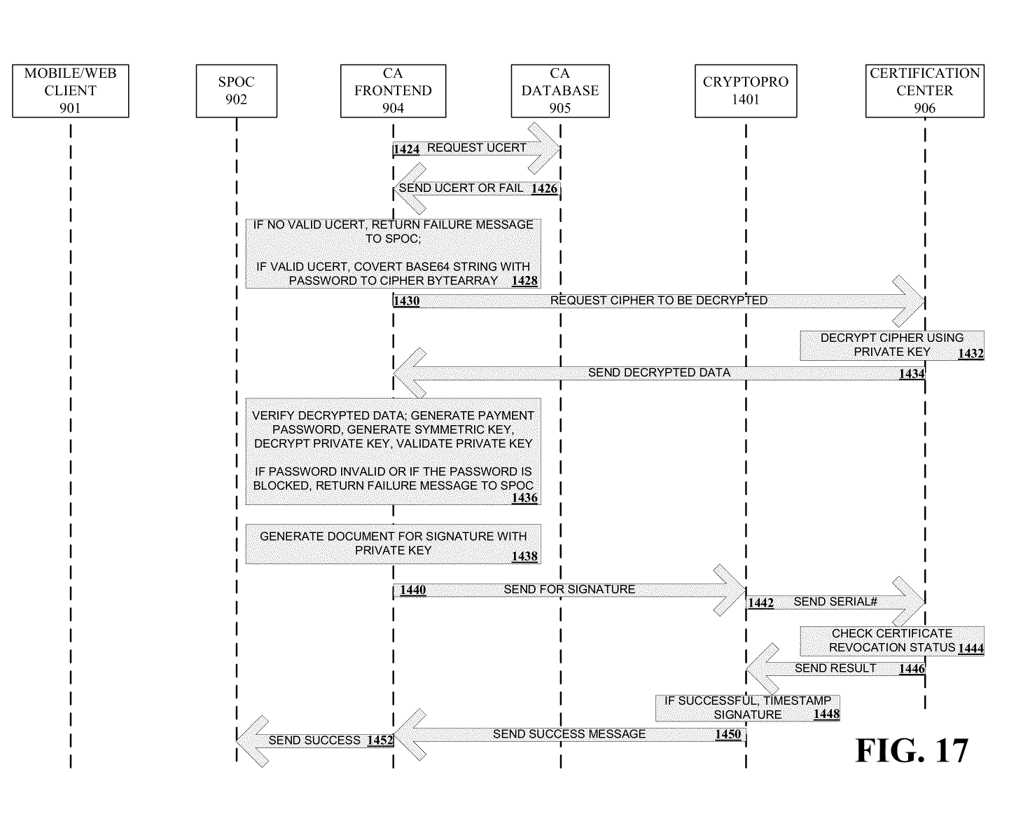

Referring now to FIGS. 16 & 17 collectively, there is illustrated an example flow diagram method for signing a document with a key. At 1402, client 901 is established with the following parameters: session string is folded into 4 byte hash value to be used as salt password; payment password is encrypted by concatenate password string and the 4-byte salt password; an RSA cipher can be created from resulting byte array using CA public key; signing a document is done with payment, encrypted payment password, and the document of the text. Signature is calculated using SHA1 with RSA algorithm and private key of device certificate.

At 1404, the data referenced at 1402 is sent to SPOC 902. At 1406, the session can be established using salt password. At 1408, the data referenced at 1402 is sent to CA frontend 904. At 1410, a certificate request is made to certification center 906. At 1412, certification center 906 has a dedicated CA certificate and private key used for user certificate authorization, device certificate authorization, and payment password encryption. At 1414, CA certificate is sent to CA frontend 904.

At 1416, the public key from CA certificate can be used to verify that the device certificate is signed against CA private key. If this is not verified, send a failure message to SPOC 904. The device certificate can also be verified for expiration. If this is not verified, send a failure message to SPOC 904. At 1418, CA frontend 904 can request a serial# related to the device certificate. At 1420, CA frontend can successfully receive a user id based on a sent serial# or alternatively receive a message that the device certificate associated with the serial# is not registered to any user id, and if so, return a failure message to SPOC 902.

At 1422, the userid received can be verified that it equals the user id from the device certificate. If they are not equal, CA frontend 904 can return a failure message to SPOC 902. The signature of the payment, encrypted password, and document can then be verified using the public key of the device certificate. If the signature is invalid, and error message can be returned to SPOC 902. At 1424, CA frontend 904 can request a user certificate from CA database 905 based on a sent user ID. At 1426, if a valid user certificate is available, CA database 905 can return the user certificate. At 1428, if there is no valid user certificate, a failure message can be returned to SPOC 902. If a valid user certificate is received, convert base64 string with encrypted password to cipher byte array.

At 1430, the byte array, along with a request for it to be decrypted can be sent to certification center 906. At 1432, the cipher can be decrypted using a CA private key. At 1434, the decrypted data can be returned to CA frontend 904. At 1436, the decrypted data can be verified by folding password salt string into a 4 byte hash value and compare the calculated hash with the 4 trailing byes of the decrypted. If not verified, a failure message can be sent to SPOC 902. The 4 trailing bytes of the decrypted data can be used as payment password. An AES symmetric key can be generated based on the payment password. The PKCS#8 private key can be decrypted with the symmetric key. The private key can then be validated using the public key from the user certificate. If private and public keys do not match, or if the password is blocked, a failure message can be returned to SPOC 902.

At 1438, the document can be generated for signature with private key. The document can be a CMS signed data structure in CAdES-BES format. The data can be signed against the private key using the SHA1withRSA algorithm. At 1440, the document can be sent to cryptopro 1401 for signature. At 1442, cryptorpo can send the certificate serial # to certification center 906. At 1444, the serial# can be checked for revocation status, if revoked, at 1446 a failure message can be returned to SPOC 902. At 1448, if the valid, the document can be time stamped. At 1450-52, success messages, including text of the signed document, can be returned to SPOC 902 and eventually to client 901.

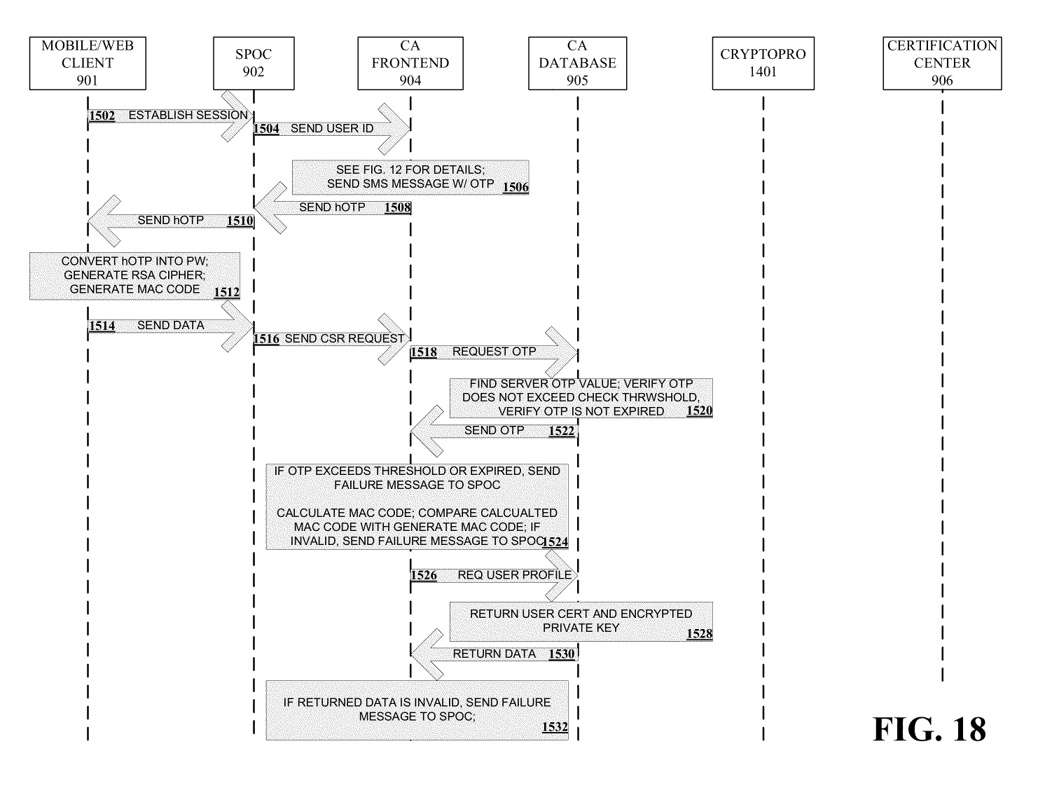

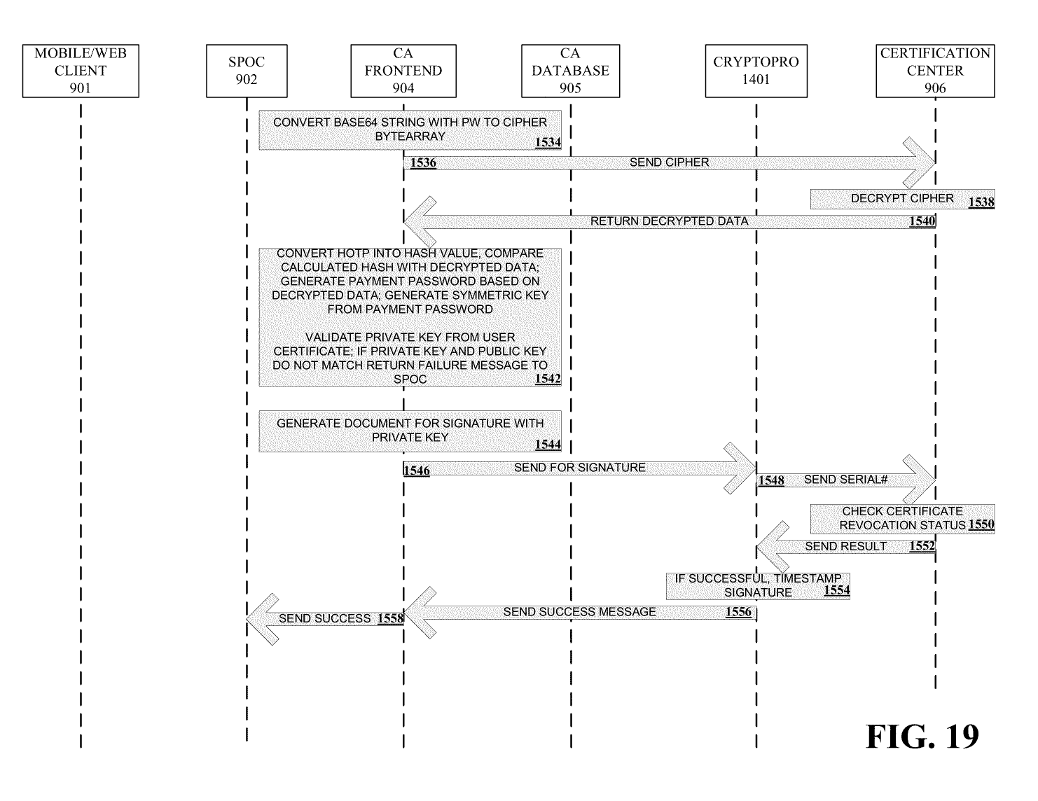

Referring now to FIGS. 18 & 19 collectively, there is illustrated an example flow diagram method for signing a document with a one time password. At 1502, a session can be established between client 901 and SPOC 902. At 1504, SPOC 902 can send the user id related to the established sessions to CA frontend 904. At 1506, a one time password can be sent to the user via SMS message, as more fully described with respect to FIG. 14. At 1508, CA frontend 904 can return hOTP to SPOC 902. At 1510, SPOC 902 can return hOTP to client 901.

At 1512, client 901 can fold hOTP string into a 4-byte hash value to be as a salt password. Payment password can be encrypted by concatenating the payment password and the 4-byte salt password. An RSA cipher can then be generated from the resulting byte array using a CA public key. A MAC can be generated based on hOTP, payment details, encrypted payment password, and the text of the document to be signed. MAC is calculated using HmacSHA1 algorithm with OTP server as a secret key.

At 1514, the data generated at 1512 can be sent to SPOC 902. At 1516, a certificate signed request can be sent to CA frontend 904. As a part of the certificate signing request, the 1512 data is included. At 1518, CA frontend 904 can request server OTP from CA database 905 by sending hOTP. At 1520, CA database 905 can find server OTP using hOTP, increase an OTP check counter, invalidate the OTP if the check counter exceeds a security threshold, and verify that the server OTP is not expired. At 1522, CA database 905 can return the results from 1520 to CA frontend 904.

At 1524, if the OTP check counter exceeded the threshold, or if the server OTP is expired, a failure message can be sent to SPOC 902. A MAC can then be calculated based on hOTP, payment details, encrypted payment password, and document text using HmacSHA1 algorithm with server OTP value. The generated MAC can be compared with the MAC from the request sent at 1518. If they are not equal, a failure message can be sent to SPOC 902.

At 1526, a user profile can be requested by sending a user id to CA database 905. At 1528, CA database 905 can retrieve a user certificate and encrypted private key for the user ID if available. If they are not available, a failure message can be returned to SPOC 902. At 1530, the user certificate and encrypted password can be returned to CA frontend 904. At 1532, the user certificate can be verified for expiration, if the certificate is expired, a failure message can be sent SPOC 902. The phone number from OTP can be compared with phone# from CA DB 905, if they are not equal, a failure message can be returned to SPOC 902.

At 1534 the encrypted password can be converted with base64 string to a cipher byte array. At 1536, the cipher can be sent to certification center 906. At 1538, certification center 9066 can decrypt the cipher using CA private key. At 1540, the decrypted data can be returned to CA frontend.

At 1542, hOTP can be converting into a 4-byte hash value used as a salt password. The calculated hash can then be compared with the 4 trailing bytes of the decrypted data, if they do not match, a failure message can be returned to SPOC 902. The trailing 4-bytes of the decrypted data can be used as payment password, an AES symmetric key can be generated from the payment password, a PKCS #8 private key can be decrypted using the symmetric key. The private key can then validated using the public key from the user certificate. If the private and public keys do not match, a failure message can be returned to SPOC 902.

At 1544, a document can be generated for signature with the private key. The document can be in CAdES-BES format and/or XML. The document can be signed against the private key using the SHAlwithRSA algorithm. At 1546, the document can be sent to cryptopro 1401 for signature. At 1548, the serial# of the certificate can be sent to certification center 906 for verification of non-revocation. At 1550, the revocation status can be checked. A t 1552, the revocation status can be returned to cryptopro 1401. If the user certificate is revoked, a failure message can be returned to SPOC 902. If the user certificate is valid, at 1554, the document can be time stamped for signature. At 1556, and 1558, messages of success can be relayed to SPOC 902.

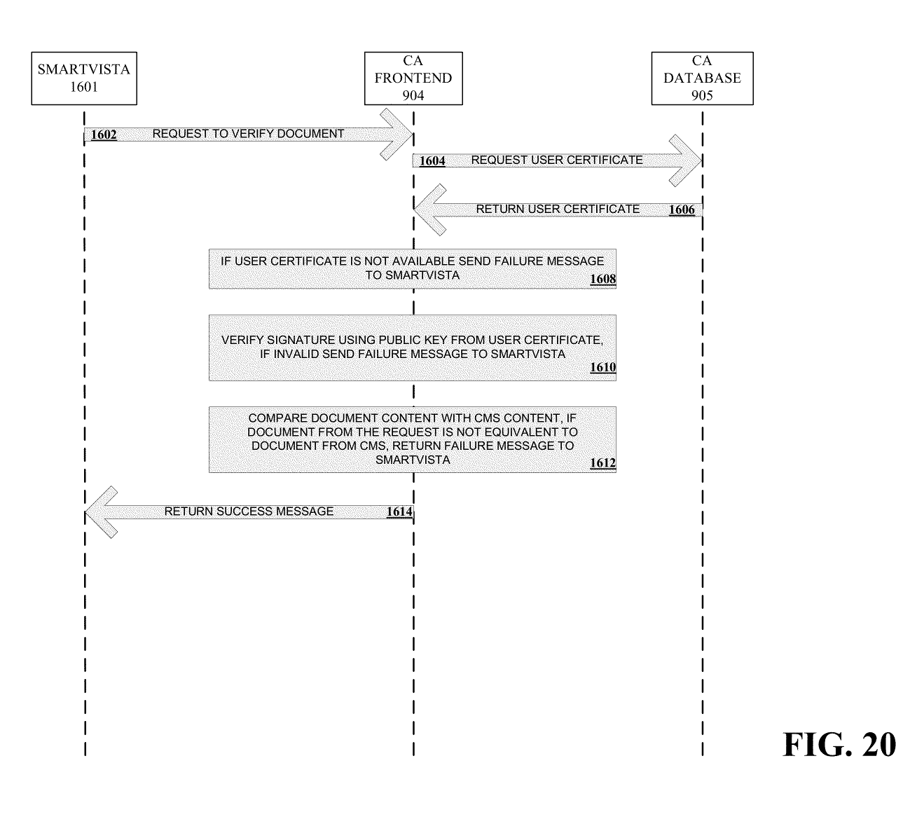

Referring now to FIG. 20, there is illustrated an example flow diagram method for verifying a document. Smartvista 1601 is a server or application used to aid in Single Euro Payments Area (“SEPA”) clearing. At 1602, SmartVista 1601 can request to verify a document with CA frontend 904. As a part of the request, SmartVista can send a user id, the document, and the signature. At 1604, CA frontend 904 can request a user certificate from CA database 905 by sending the user id. At 1606, the user certificate can be returned. At 1608, if the user certificate is not available, a failure message can be sent to SmartVista 1601.

At 1610, the signature can be verified using public key from the user certificate. If the signature is not valid, a failure message can be sent to SmartVista 1601. At 1612, the document content can compared with CMS content to determine if they are equivalent, if they are not equivalent, a failure message can be returned to SmartVista 1601. If equivalent, a success message can be returned to SmartVista 1601 at 1614.

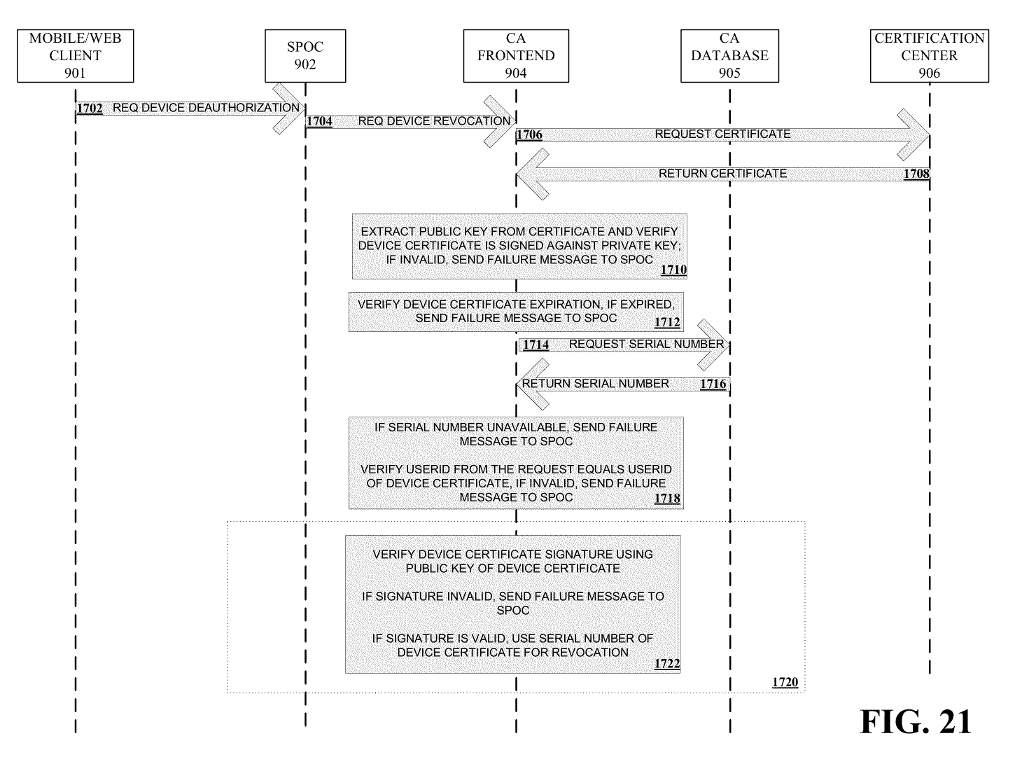

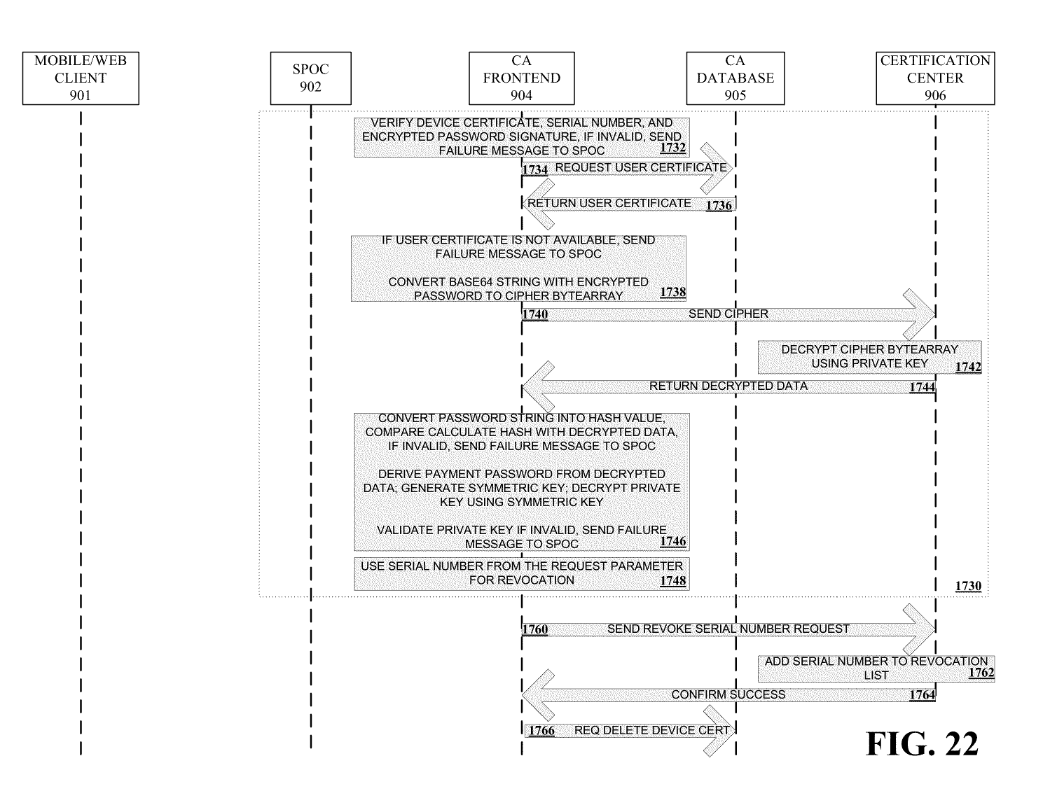

Referring now to FIGS. 21 & 22 collectively, there is illustrated an example flow diagram method for revoking a device certificate. At 1702, a sessions can be established between client 901 and SPOC 902 where client 901 request device deauthroization by sending the request along with the device certificate, a serial #, an encrypted password, a signature and a salt password. At 1704, the data sent at 1702 is further sent to CA frontend 904 from SPOC 902. At 1706, CA frontend 904 request a CA certificate from certification center 906. Certification center has a dedicate CA certificate and private key to be used for user certificate authorization, device certificate authorization, and payment password encryption. At 1708, the CA certificate can be returned to CA frontend 904.

At 1710, the public key can be extracted from CA certificate to verify that the device certificate is signed against the CA private key. If the device certificate is valid, a failure message can be returned to SPOC 902. At 1712, the device certificate can be verified for expiration, if the device certificate is expired, a failure message can be sent to SPOC 902. At 1714, the device certificate can be sent to CA database 905 for the purpose of retrieving a serial # related to the device. At 1716, the serial number can be returned to CA frontend 904. At 1718, if the serial # is unavailable, a failure message can be sent to SPOC 902. Additionally, the user id from the request can be compared to the user id of the device certificate. If they do not match, a failure message can be sent to SPOC 902.

Two alternate methods can diverge after step 1718. Method 1720 including step 1722 can unfold if the serial # was not included in the request. Method 1730 including steps 1732-1748 can unfold if the serial # was included in the request.

At 1722, under alternate method 1720, the device certificate can be verified using the public key of the device certificate. If the signature is invalid, a failure message can be sent to SPOC 902. If the signature is valid, use the serial # of the device certificate during the revocation process beginning at step 1760.

At 1732, under method alternate method 1730, the device certificate can be verified along with the serial #, the encrypted password and signature. If any of the three are invalid, a failure message can be sent to SPOC 902. At 1734, a user certificate can be requested based on sending a user id. At 1736, the user certificate can be returned. At 1738, if the user certificate is not available, a failure message can be sent to SPOC. Additionally the Base64 string can be converted with encrypted password to a cipher byte array. At 1740, the cipher can be sent to certification center 906. At 1742, the cipher byte array can be decrypted using a CA private key. At 1744, the decrypted data can be returned to CA frontend 904. At 1746, the password salt string can be converted into a 4-byte hash value used as password salt, compare the calculated hash with the 4 trailing bytes of the decrypted data. If they are not equivalent, return a failure message to SPOC 902. The trailing 4-bytes of the decrypted data can be cut to get payment password. An AES symmetric key can be generated from the payment password. The private key can be decrypted using PKCS #8 with the symmetric. The private key can then be check for validating by comparing it with the public key from the user certificate. If the public key and private key do not match, a failure message can be sent to SPOC 902. The serial # from the request parameter can then be used in revocation process beginning at step 1760.

At 1760, a revoke serial number request can be sent to certification center 906 along with the serial # desired to be revoked. At 1762, the serial # can be added into a revocation list. At 1764, the successful add can be confirmed to CA frontend 904. At 1766, a request to delete the device certificate based on the serial # can be sent to CA database 905, to be used in deleting the device certificate.

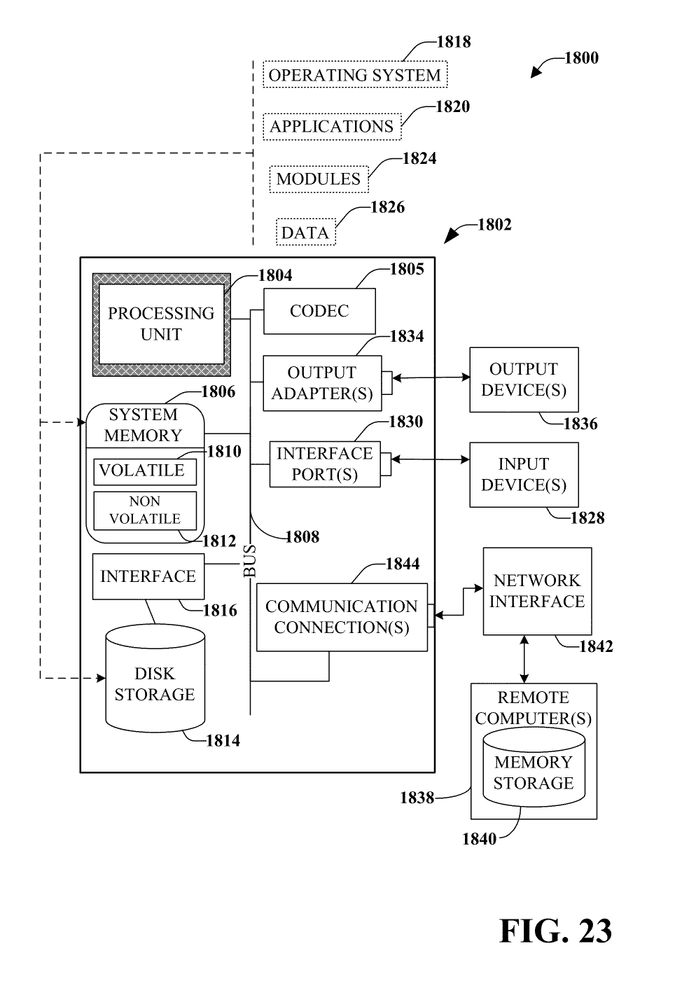

With reference to FIG. 23, a suitable environment 1800 for implementing various aspects of the claimed subject matter includes a computer 1802. The computer 1802 includes a processing unit 1804, a system memory 1806, a codec 1805, and a system bus 1808. The system bus 1808 couples system components including, but not limited to, the system memory 1806 to the processing unit 1804. The processing unit 1804 can be any of various available processors. Dual microprocessors and other multiprocessor architectures also can be employed as the processing unit 1804.

The system bus 1808 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 1806 includes volatile memory 810 and non-volatile memory 1812. The basic input/output system (BIOS), containing the basic routines to transfer information between elements within the computer 1802, such as during start-up, is stored in non-volatile memory 1812. By way of illustration, and not limitation, non-volatile memory 1812 can include read only memory (ROM), programmable ROM (PROM), electrically programmable ROM (EPROM), electrically erasable programmable ROM (EEPROM), or flash memory. Volatile memory 1810 includes random access memory (RAM), which acts as external cache memory. According to present aspects, the volatile memory may store the write operation retry logic (not shown in FIG. 23) and the like. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM).

Computer 1802 may also include removable/non-removable, volatile/non-volatile computer storage media. FIG. 23 illustrates, for example, a disk storage 1814. Disk storage 1814 includes, but is not limited to, devices like a magnetic disk drive, solid state disk (SSD) floppy disk drive, tape drive, Jaz drive, Zip drive, LS-100 drive, flash memory card, or memory stick. In addition, disk storage 1814 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1814 to the system bus 1808, a removable or non-removable interface is typically used, such as interface 1816.

It is to be appreciated that FIG. 23 describes software that acts as an intermediary between users and the basic computer resources described in the suitable operating environment 1800. Such software includes an operating system 1818. Operating system 1818, which can be stored on disk storage 1814, acts to control and allocate resources of the computer system 1802. Applications 1820 take advantage of the management of resources by operating system 1818 through program modules 1824, and program data 1826, such as the boot/shutdown transaction table and the like, stored either in system memory 1806 or on disk storage 1814. It is to be appreciated that the claimed subject matter can be implemented with various operating systems or combinations of operating systems.

A user enters commands or information into the computer 1802 through input device(s) 1828. Input devices 1828 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1804 through the system bus 1808 via interface port(s) 1830. Interface port(s) 1830 include, for example, a serial port, a parallel port, a game port, and a universal serial bus (USB). Output device(s) 1836 use some of the same type of ports as input device(s) 1828. Thus, for example, a USB port may be used to provide input to computer 1802, and to output information from computer 1802 to an output device 1836. Output adapter 1834 is provided to illustrate that there are some output devices 1836 like monitors, speakers, and printers, among other output devices 1836, which require special adapters. The output adapters 1834 include, by way of illustration and not limitation, video and sound cards that provide a means of connection between the output device 1836 and the system bus 1808. It should be noted that other devices and/or systems of devices provide both input and output capabilities such as remote computer(s) 1838.

Computer 1802 can operate in a networked environment using logical connections to one or more remote computers, such as remote computer(s) 1838. The remote computer(s) 1838 can be a personal computer, a bank server, a bank client, a bank processing center, a certificate authority, a router, a network PC, a workstation, a microprocessor based appliance, a peer device, a smart phone, a tablet, or other network node, and typically includes many of the elements described relative to computer 1802. For purposes of brevity, only a memory storage device 1840 is illustrated with remote computer(s) 1838. Remote computer(s) 1838 is logically connected to computer 1802 through a network interface 1842 and then connected via communication connection(s) 1844. Network interface 1842 encompasses wire and/or wireless communication networks such as local-area networks (LAN) and wide-area networks (WAN) and cellular networks. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1844 refers to the hardware/software employed to connect the network interface 1842 to the bus 1808. While communication connection 1844 is shown for illustrative clarity inside computer 1802, it can also be external to computer 1802. The hardware/software necessary for connection to the network interface 1842 includes, for exemplary purposes only, internal and external technologies such as, modems including regular telephone grade modems, cable modems and DSL modems, ISDN adapters, and wired and wireless Ethernet cards, hubs, and routers.

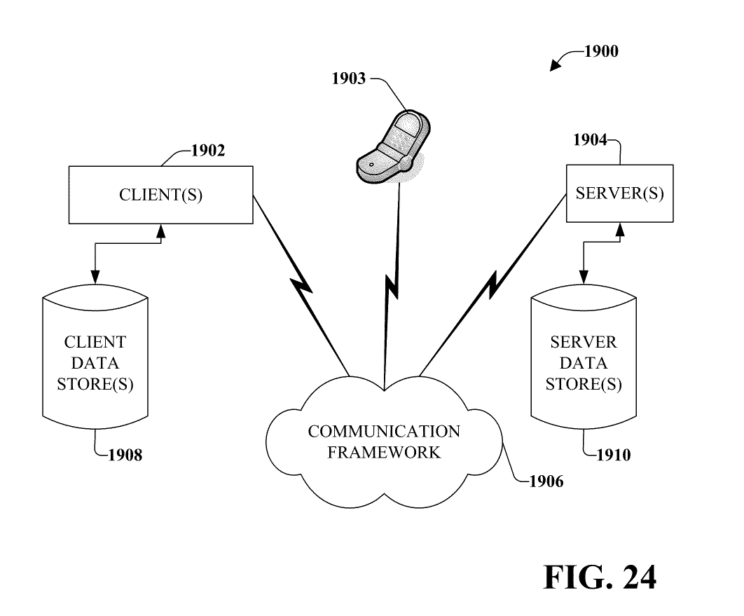

Referring now to FIG. 24, there is illustrated a schematic block diagram of a computing environment 1900 in accordance with the subject specification. The system 900 includes one or more client(s) 1902, which can include an application or a system that accesses a service on the server 1904. The client(s) 1902 can be hardware and/or software (e.g., threads, processes, computing devices). The client(s) 1902 can house cookie(s) and/or associated contextual information by employing the specification, for example.

The system 1900 also includes one or more server(s) 1904. The server(s) 1904 can also be hardware or hardware in combination with software (e.g., threads, processes, computing devices). The servers 1904 can house threads to perform, for example, encryption, decryption, calculations, etc. One possible communication between a client 1902 and a server 1904 can be in the form of a data packet adapted to be transmitted between two or more computer processes where the data packet contains, for example, a certificate. The data packet can include a cookie and/or associated contextual information, for example. The system 1900 includes a communication framework 1906 (e.g., a global communication network such as the Internet) that can be employed to facilitate communications between the client(s) 1902 and the server(s) 1904.

Communications can be facilitated via a wired (including optical fiber) and/or wireless technology. The client(s) 1902 are operatively connected to one or more client data store(s) 1908 that can be employed to store information local to the client(s) 1902 (e.g., cookie(s) and/or associated contextual information). Similarly, the server(s) 1904 are operatively connected to one or more server data store(s) 1910 that can be employed to store information local to the servers 1904.

The illustrated aspects of the disclosure may also be practiced in distributed computing environments where certain tasks are performed by remote processing devices that are linked through a communications network. In a distributed computing environment, program modules can be located in both local and remote memory storage devices.

The processes described above can be embodied within hardware, such as a single integrated circuit (IC) chip, multiple ICs, an application specific integrated circuit (ASIC), or the like. Further, the order in which some or all of the process blocks appear in each process should not be deemed limiting. Rather, it should be understood that some of the process blocks can be executed in a variety of orders that are not all of which may be explicitly illustrated herein.

What has been described above includes examples of the implementations of the present invention. It is, of course, not possible to describe every conceivable combination of components or methods for purposes of describing the claimed subject matter, but many further combinations and permutations of the subject embodiments are possible. Accordingly, the claimed subject matter is intended to embrace all such alterations, modifications, and variations that fall within the spirit and scope of the appended claims. Moreover, the above description of illustrated implementations of this disclosure, including what is described in the Abstract, is not intended to be exhaustive or to limit the disclosed implementations to the precise forms disclosed. While specific implementations and examples are described herein for illustrative purposes, various modifications are possible that are considered within the scope of such implementations and examples, as those skilled in the relevant art can recognize.

In particular and in regard to the various functions performed by the above described components, devices, circuits, systems and the like, the terms used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the various embodiments includes a system as well as a computer-readable storage medium having computer-executable instructions for performing the acts and/or events of the various methods of the claimed subject matter.

What is claimed is:

1. A system, comprising:
a memory to store computer executable components; and
a processor that facilitates execution of computer executable components stored within the memory, the computer executable components, comprising:
a receiving component that receives a device identifier (ID) from a modem device;
a subscriber data component that retrieves profile data representing a personal profile based on the device ID; and
a certificate component that generates a non-qualified digital certificate and stores the non-qualified digital certificate in a certificate data store wherein the non-qualified digital certificate is associated with the device ID and the profile data.

2. The system of claim 1, wherein the receiving component receives the device ID from the modem device in response to a determination that the modem device has at least begun being installed.

3. The system of claim 1, further comprising:
a validation component that generates a service agreement based on the device ID and the profile data and sends the service agreement to the modem device.

4. The system of claim 3, wherein the receiving component further receives signed service agreement data representing a signed service agreement from the modem device.

5. The system of claim 4, wherein the validation component validates the signed service agreement data based on, at least in part, the device ID.

6. The system of claim 5, wherein, in response to determining the signed service agreement was validated, the validation component transforms the non-qualified digital certificate in the certificate data store into a qualified digital certificate.

7. The system of claim 6, further comprising:
a third party component that sends an application to the modem device, wherein the application allows the qualified digital certificate in the certificate data store to be used in a transaction with a third party device.

8. The system of claim 1, wherein the non-qualified digital certificate is not-qualified to perform transactions.

9. A client device, comprising:
at least one memory that stores computer executable components; and
at least one input; and
a processor that facilitates execution of one or more of the computer executable components stored within the at least one memory, the one or more computer executable components comprising:
an initialization component that sends a device identifier (ID) associated with a modem device to a service provider device in response to determining that the modem device has at least begun installation;
a receiving component that receives service agreement data representing a service agreement from the service provider device;
a display component that in response to receiving the service agreement data, displays the service agreement data; and
a signature component that receives, from the at least one input, signature data representing a signature, wherein the signature data is sent to the service provider device in response to reception of the signature data.

10. The client device of claim 9, further comprising:
a third party component that receives and installs a third party application from the service provider device, wherein the third party application enables the client device to conduct a transaction with a third party device or service based on the service agreement data.

11. A method, comprising:
receiving, from a system including a processor, a device identifier (ID) from a modem device;
retrieving profile data representing a personal profile based on the device ID;
generating a non-qualified digital certificate wherein the non-qualified digital certificate is associated with the device ID and the profile data; and
initiating storing the non-qualified digital certificate in a certificate data store.

12. The method of claim 11, wherein the receiving the device ID from the modem device is in response to the modem device being determined to have been installed.

13. The method of claim 11, further comprising:
generating agreement data representing a service agreement based on the device ID and the profile data; and
sending the agreement data to the modem device.

14. The method of claim 13, further comprising:
receiving signed agreement data representing a signed service agreement from the modem device.

15. The method of claim 14, further comprising:
validating the signed agreement data based on, at least in part, the device ID.

16. The method of claim 15, wherein,
in response to determining the signed service agreement data has been validated, transforming the non-qualified digital certificate in the certificate data store into a qualified digital certificate.

17. The method of claim 16, further comprising:
sending an application to the modem device, wherein the application enables the qualified digital certificate to be used in a transaction with a third party device or service.

18. The method of claim 11, wherein the non-qualified digital certificate is not-qualified to perform transactions.

19. A computer-readable storage medium comprising computer-executable instructions that, in response to execution, cause a computing system including a processor to perform operations, comprising:
receiving a device identifier (ID) from a modem associated with a long term evolution (LTE) network;
retrieving profile data representing a personal profile based on the device ID; and
generating a non-qualified digital certificate including associating the non-qualified digital certificate with the device ID and the profile data; and
directing the non-qualified digital certificate to be stored in a certificate data store.

20. The computer-readable storage medium of claim 19, wherein the receiving the device ID from the modem is in response to the determining the modem has been installed.

21. The computer-readable storage medium of claim 19, further comprising:
generating agreement data representing a service agreement based on the device ID and the profile data; and
sending the agreement data to the modem.

22. The computer-readable storage medium of claim 21, further comprising:
receiving signed service agreement data representing a signed service agreement from the modem.

23. The computer-readable storage medium of claim 22, further comprising:
validating the signed service agreement data based on, at least in part, the device ID.

24. The computer-readable storage medium of claim 23, wherein,
in response to determining the signed service agreement data has been validated, transforming the non-qualified digital certificate to a qualified digital certificate.

25. The computer-readable storage medium of claim 24, further comprising:
sending an application to the modem, facilitating use of the qualified digital certificate in a transaction with a third party device or service.
